(19) United States
(12) Patent Application Publication
(10) Pub. No.: US 2017/0252814 A1
(43) Pub. Date: Sep. 7, 2017

(54) PLASMA DEPASSIVATION

(71) Applicant: Desktop Metal, Inc., Burlington, MA (US)

(72) Inventors: Jonah Samuel Myerberg, Lexington, MA (US); Yet-Ming Chiang, Weston, MA (US); Christopher Allan Schuh, Wayland, MA (US); Anastasios John Hart, Waban, MA (US); Ricardo Fulop, Lexington, MA (US); Richard Remo Fontana, Cape Elizabeth, ME (US); Nicholas Mark Mykulowycz, Boxford, MA (US); Joseph Yosup Shim, Medford, MA (US); Michael Andrew Gibson, Boston, MA (US); Jan Schroers, Guilford, CT (US); Emanuel Michael Sachs, Newton, MA (US)

(21) Appl. No.: 15/450,699

(22) Filed: Mar. 6, 2017

Related U.S. Application Data
(63) Continuation of application No. PCT/US17/20817, filed on Mar. 3, 2017.
(60) Provisional application No. 62/303,310, filed on Mar. 3, 2016.

(51) Int. Cl. B22F 3/115; B33Y 50/02; B33Y 30/00; B22F 3/00; B33Y 10/00

(52) U.S. Cl. CPC B22F 3/115; B22F 3/008; B33Y 10/00; B33Y 30/00; B33Y 50/02

(57) ABSTRACT

A printer fabricates an object from a computerized model using a fused filament fabrication process and a metallic build material. A plasma depassivation wash is applied during deposition to remove oxidation and improve interlayer bonding between successive layers of the metallic build material. Other techniques such as ultrasonic vibration, formation of energy directors, joule heating, and the like, may be used in combination to form a mechanically robust bond between layers.

### CROSS-REFERENCE TO RELATED APPLICATIONS

This application is a continuation filed under 35 U.S.C. §111(a) that claims priority under 35 U.S.C. §120 and §365(c) to International App. No. PCT/US17/20817 filed on Mar. 3, 2017, which claims priority to U.S. Prov. App. No. 62/303,310 filed on Mar. 3, 2016, with the entire contents of each of these applications hereby incorporated herein by reference.

This application is related to the following U.S. patent applications: U.S. Prov. App. No. 62/268,458 filed on Dec. 16, 2015; U.S. application Ser. No. 15/382,535 filed on Dec. 16, 2016; and U.S. application Ser. No. 15/059,256 filed on Mar. 2, 2016. Each the foregoing applications is hereby incorporated by reference in its entirety.

### TECHNICAL FIELD

The present disclosure generally relates to additive manufacturing, and more specifically to the three-dimensional printing of metal objects.

### BACKGROUND

Fused filament fabrication provides a technique for fabricating three-dimensional objects from a thermoplastic or similar materials. Machines using this technique can fabricate three-dimensional objects additively by depositing lines of material in layers to additively build up a physical object from a computer model. While these polymer-based techniques have been changed and improved over the years, the physical principles applicable to polymer-based systems may not be applicable to metal-based systems, which tend to pose different challenges. There remains a need for three-dimensional printing techniques suitable for metal additive manufacturing.

### SUMMARY

Various improvements to additive manufacturing are disclosed, including techniques for adapting fused filament fabrication processes to fabricate metal objects with metallic build materials.

A printer fabricates an object from a computerized model using a fused filament fabrication process and a metallic build material. A plasma depassivation wash is applied during deposition to remove oxidation and improve interlayer bonding between successive layers of the metallic build material. Other techniques such as ultrasonic vibration, formation of energy directors, joule heating, and the like, may be used in combination to form a mechanically robust bond between layers.

A printer for three-dimensional fabrication of metallic objects may include a reservoir with an entrance to receive a metallic build material from a source, the metallic build material having a working temperature range with a flowable state exhibiting rheological properties suitable for fused filament fabrication, a heating system operable to heat the metallic build material within the reservoir to a temperature within the working temperature range, a nozzle including an opening that provides an exit path for the metallic build material from the reservoir, a drive system operable to mechanically engage the metallic build material and to advance the metallic build material from the source into the reservoir with sufficient force to extrude the metallic build material, while at a temperature within the working temperature range, through the opening in the nozzle, and a plasma source directed at the metallic build material exiting the nozzle.

Implementations may include one or more of the following features. The printer may further include an ultrasound vibrator coupled to the nozzle and configured to apply ultrasound energy through the nozzle to the metallic build material exiting the nozzle. The printer may further include a shaping fixture to impose at least one ridge on a top surface of the metallic build material exiting the nozzle. The printer may further include a joule heating system configured to pass a current through the metallic build material across an interface between a first layer of the metallic build material exiting the nozzle and an underlying layer of the metallic build material. The metallic build material may include a bulk metallic glass, where the working temperature range includes a temperature above a glass transition temperature for the bulk metallic glass and below a melting temperature for the bulk metallic glass. The metallic build material may include an off-eutectic composition, where the working temperature range includes a range of temperatures between a lowest and highest melting temperature. The metallic build material may include a composite material having a metallic base that melts at a first temperature and a high-temperature inert second phase in particle form that remains inert up to at least a second temperature greater than the first temperature, where the working temperature range includes a range of temperatures above a melting point of the metallic base. The metallic build material may include a peritectic composition and the working temperature range may include a range of temperatures where the peritectic composition exhibits an equilibrium volume fraction containing a substantial percentage by volume of liquid and a substantial percentage by volume of solid, where the peritectic composition exhibits a medium viscosity of between about one hundred and one thousand pascal seconds. The printer may include a fused filament fabrication additive manufacturing system. The printer may further include a build plate and a robotic system, the robotic system configured to move the nozzle in a three-dimensional path relative to the build plate in order to fabricate an object from the metallic build material on the build plate according to a computerized model of the object. The printer may further include a controller configured by computer executable code to control the heating system, the drive system, and the robotic system to fabricate the object on the build plate from the metallic build material. The plasma source may include a variable chemistry plasma source. The plasma source may include an ion plasma source. The plasma source may be directed at a location where the metallic build material exiting the nozzle joins an underlying layer of the metallic build material. The plasma source may be directed at a location on an underlying layer of the metallic build material before the metallic build material exiting the nozzle is deposited over the location. The metallic build material may include aluminum.

A method for controlling a printer in a three-dimensional fabrication of a metallic object may include extruding a metallic build material through a nozzle of the printer, moving the nozzle along a build path relative to a build plate of the printer to fabricate an object on the build plate in a fused filament fabrication process based on a computerized model of the object, and joining the metallic build material as it exits the nozzle to an underlying layer of the metallic build material within a plasma stream.

Implementations may include one or more of the following features. The method may further include applying ultrasound energy to the metallic build material exiting the nozzle while it is deposited over the underlying layer. The metallic build material may include at least one of a bulk metallic glass and an off-eutectic composition of eutectic systems. The metallic build material may include a composite material having a metallic base that melts at a first temperature and a high-temperature inert second phase in particle form that remains inert up to at least a second temperature greater than the first temperature, where a working temperature range of the metallic build material includes a range of temperatures above a melting point of the metallic base. The metallic build material may include aluminum.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 is a block diagram of an additive manufacturing system.

FIG. 2 is a block diagram of a computer system.

FIG. 3 shows a schematic of a time-temperature-transformation (T) diagram for an exemplary bulk metallic glass.

FIG. 4 shows a phase diagram for an off-eutectic composition of eutectic systems.

FIG. 5 shows a phase diagram for a peritectic system.

FIG. 6 shows an extruder for a three-dimensional printer.

FIG. 7 shows a flow chart of a method for operating a printer in a three-dimensional fabrication of an object.

FIG. 8 shows an extruder for a three-dimensional printer.

FIG. 9 shows an extruder for a three-dimensional printer.

FIG. 10A shows a spread forming deposition nozzle.

FIG. 10B shows a spread forming deposition nozzle.

FIG. 11 shows a cross section of a nozzle for fabricating energy directors.

FIG. 12 shows an energy director formed in a layer of deposited build material.

FIG. 13 shows a top view of a nozzle exit with multiple grooves.

FIG. 14 shows a top view of a nozzle exit with a number of protuberances.

FIG. 15 illustrates a method for monitoring temperature with the Seebeck effect.

FIG. 16 shows an extruder for a three-dimensional printer.

FIG. 17 shows a method for using a nozzle cleaning fixture in a three-dimensional printer.

FIG. 18 shows a method for detecting a nozzle position.

FIG. 19 shows a method for using dissolvable bulk metallic glass support materials.

FIG. 20 shows a method for controllably securing an object to a build plate.

FIG. 21 shows a method for an extrusion control process using force feedback.

### DETAILED DESCRIPTION

Embodiments will now be described more fully hereinafter with reference to the accompanying figures, in which preferred embodiments are shown. The foregoing may, however, be embodied in many different forms and the following description should not be construed as limiting unless explicitly stated otherwise.

All documents mentioned herein are incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the claimed embodiments.

In the following description, it is understood that terms such as “first,” “second,” “top,” “bottom,” “up,” “down,” and the like, are words of convenience and are not to be construed as limiting terms unless specifically stated to the contrary.

In general, the following description emphasizes three-dimensional printers using metal as a build material for forming a three-dimensional object. More specifically, the description emphasizes metal three-dimensional printers that deposit metal, metal alloys, or other metallic compositions for forming a three-dimensional object using fused filament fabrication or similar techniques. In these techniques, a bead of material is extruded as “roads” or “paths,” in a layered series of two dimensional patterns to form a three-dimensional object from a digital model. However, it will be understood that other additive manufacturing techniques and other build materials may also or instead be used with many of the techniques contemplated herein. Thus, although the devices, systems, and methods emphasize metal three-dimensional printing using fused filament fabrication, a skilled artisan will recognize that many of the techniques discussed herein may be adapted to three-dimensional printing using other materials (e.g., thermoplastics or other polymers and the like, or a ceramic powder loaded in an extrudable binder matrix) and other additive fabrication techniques including without limitation multijet printing, electrohydrodynamic jetting, pneumatic jetting, stereolithography, Digital Light Processor (DLP) three-dimensional printing, selective laser sintering, binder jetting and so forth. Such techniques may benefit from the systems and methods described below, and all such printing technologies are intended to fall within the scope of this disclosure, and within the scope of terms such as “printer,” “three-dimensional printer,” “fabrication system,” “additive manufacturing system,” and so forth, unless a more specific meaning is explicitly provided or otherwise clear from the context. Further, if no type of printer is stated in a particular context, then it should be understood that any and all such printers are intended to be included, such as where a particular material, support structure, article of manufacture, or method is described without reference to a particular type of three-dimensional printing process.

Many metallic build materials may be used with the techniques described herein. In one aspect, a metallic build material may include a bulk metallic glass (BMG). Bulk-solidifying amorphous alloys, or bulk metallic glasses (BMGs) are metallic alloys that have been supercooled into an amorphous, noncrystalline state. In this state, many of these alloys can be reheated above a glass transition temperature to yield a rheology suitable for extrusion in a fused filament fabrication process while retaining their non-crystalline microstructure. Thus, these materials may provide a useful working temperature range for fused filament fabrication, or any similar extrusion-based or deposition-based process while retaining an amorphous structure. Amorphous alloys also have many superior properties to their crystalline counterparts in terms of hardness, strength, and so forth. However, amorphous alloys may also impose special handling requirements. For example, the supercooled state of amorphous alloys may begin to degrade with exposure to prolonged heating, more specifically due to crystallization, which can occur even at temperatures below the melting temperature, and is not generally reversible without re-melting and supercooling the alloy.

A range of BMGs may be employed as a metallic build material in an additive manufacturing process such as fused filament fabrication or “FFF”. In general, those BMGs with greater temperature windows between a glass transition temperature (where the material can be extruded) and the melting temperature (where a material melts and crystallizes upon subsequent cooling) are preferred, although not necessary for a properly functioning FFF system. Similarly, the crystallization rate of particular alloys within this temperature window may render some BMGs more suitable than others for prolonged heating and plastic handling. At the same time, high ductility, high strength, a non-brittleness are generally desirable properties, as is the use of relatively inexpensive elemental components. While various BMG systems meet these criteria to varying degrees, these alloys are not necessary for use in a BMG FFF system as contemplated herein. Numerous additional alloys and alloy systems may be usefully employed, such as any of those described in U.S. Provisional Application No. 62/268,458, filed on Dec. 16, 2015, the entire contents of which is hereby incorporated by reference.

Other materials may also or instead provide similarly attractive properties for use as a metallic build material in a fused filament fabrication process as contemplated herein. For example, U.S. application Ser. No. 15/059,256, filed on Mar. 2, 2016 and incorporated by reference herein in its entirety, describes various multi-phase build materials using a combination of a metallic base and a high temperature inert second phase, any of which may be usefully deployed for fused filament fabrication. Thus, one useful metallic build material contemplated herein includes a metallic base that melts at a first temperature and a high temperature inert second phase in particle form that remains inert up to at least a second temperature greater than the first temperature.

In another aspect, compositions of eutectic systems that are not at the eutectic composition, also known as off-eutectic or non-eutectic compositions, may usefully be employed as a metallic build material. These off-eutectic compositions contain components that solidify in different combinations at different temperatures to provide semi-solid state with an equilibrium mixture of a solid and a liquid that collectively provide rheological properties suitable for fused filament fabrication or similar extrusion-based additive fabrication techniques. In general, an off-eutectic composition of eutectic systems may be categorized as a hypoeutectic composition or hypereutectic composition according to the relative composition of off-eutectic species in the system, any of which may be usefully maintained in a semi-solid state at certain temperatures for use in a fused filament fabrication system as contemplated herein.

A composition within a peritectic may also have a working temperature range with a semi-solid state suitable for use in a fused filament fabrication process. For example, a peritectic composition such as bronze may be used as a build material for fabricating objects as contemplated herein, particularly where the peritectic composition has a temperature range where the composition exhibits a mixture of solid and liquid phases resulting in rheological properties suitable for extrusion.

Other materials may contain metallic content such as a sinterable metallic powder or other metal powder mixed with a thermoplastic, a wax, a compatibilizer, a plasticizer, or other material matrix to obtain a relatively low-temperature metallic build material that can be extruded at low temperatures where the matrix softens (e.g., around two-hundred degrees Celsius or other temperatures well below typical metal melting temperatures). For example, materials such as metal injection molding materials or other powdered metallurgy compositions contain significant metal content, but are workable for extrusion at lower temperatures. These materials, or other materials similarly composed of metal powder and a binder system, may be used to fabricate green parts that can be debound and sintered into fully densified metallic objects, and may be used as metallic build materials as contemplated herein.

More generally, any build material with metallic content that provides a useful working temperature range with rheological properties suitable for heated extrusion may be used as a metallic build material as contemplated herein. The limits of this window or range of working temperatures will depend on the type of composition (e.g., BMG, off-eutectic, etc.) and the metallic and non-metallic constituents. For bulk metallic glasses, the useful temperature range is typically between the glass transition temperature and the melting temperature, subject to crystallization constraints. For off-eutectic compositions, the useful temperature range is typically between the eutectic temperature and a liquidus temperature, or between a solidus temperature and a liquidus temperature (although other metrics such as the creep relaxation temperature may be usefully employed to quantify the top boundary of the temperature window, above which the viscosity of the composition drops quickly). In this context, the corresponding working temperature range is referred to for simplicity as a working temperature range between a lowest and highest melting temperature for the off-eutectic composition. For multi-phase build materials with an inert high temperature second phase, the window may begin at any temperature above the melting temperature of the base metallic alloy, and may range up to any temperature where the second phase remains substantially inert within the mixture.

According to the foregoing, the term “metallic build material,” as used herein, is intended to refer to any metal-containing build material, which may include elemental or alloyed metallic components, as well as compositions containing other non-metallic components which may be added for any of a variety of mechanical, rheological, aesthetic, or other purposes. For example, non-metallic strengtheners may be added to a metallic material. As another example, metallic powders may be combined with a wax, a polymer, a plasticizer, a compatibilizer or other binder system or combination of these for extrusion. Although this composition may not conventionally be referred to as metallic, and lacks many typical bulk properties of a metal (such as good electrical conductivity), a net shape object fashioned from such a material may usefully be sintered into a metallic object, and such a build material—useful for fabricating metallic objects—is considered a “metallic build material” for the purposes of the following discussion.

Certain materials such as ceramics may also be suitable for use as a build material using many of the techniques disclosed herein. Thus a “build material” as described herein should be understood to further include such ceramic build materials and other materials unless explicitly stated to the contrary or otherwise clear from the context. A build material may also or instead include a sinterable powder, which may be a metallic powder, a ceramic powder, or any other powdered material suitable for sintering into a densified final part. These sinterable powders, whether metallic or otherwise, may be combined with any suitable binder system for extrusion and subsequent processing into a final part.

In some of the applications described herein, the conductive properties of the metallic build material are used in the fabrication process, e.g. to provide an electrical path for inductive or resistive heating. For these uses, the term metallic build material should more generally be understood to mean a metal-bearing build material with sufficient conductance to form an electrical circuit for therethrough for carrying current. Where a build material is specifically used for carrying current in an additive fabrication application, these materials may also be referred to as conductive metallic build materials.

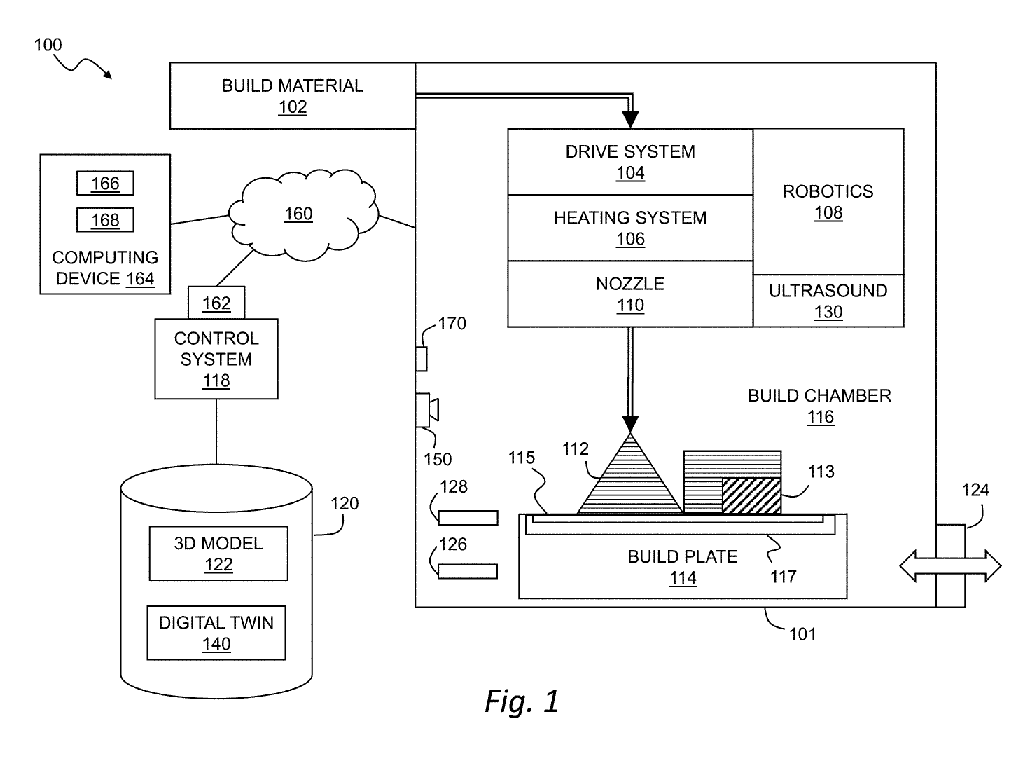

FIG. 1 is a block diagram of an additive manufacturing system. The additive manufacturing system 100 shown in the figure may, for example, be a metallic printer including a fused filament fabrication additive manufacturing system, or include any other additive manufacturing system or combination of manufacturing systems configured for three-dimensional printing using a metallic build material such as a metallic alloy or bulk metallic glass. However, the additive manufacturing system 100 may also or instead be used with other build materials including plastics, ceramics, and the like, as well as combinations of the foregoing.

In general, the additive manufacturing system may include a three-dimensional printer 101 (or simply ‘printer’ 101) that deposits a metal, metal alloy, metal composite or the like using fused filament fabrication or any similar process. In general, the printer 101 may include a build material 102 that is propelled by a drive system 104 and heated to an extrudable state by a heating system 106, and then extruded through one or more nozzles 110. By concurrently controlling robotics 108 to position the nozzle(s) along an extrusion path relative to a build plate 114, an object 112 may be fabricated on the build plate 114 within a build chamber 116. In general, a control system 118 may manage operation of the printer 101 to fabricate the object 112 according to a three-dimensional model using a fused filament fabrication process or the like.

The build material 102 may, for example, include any of the amorphous alloys described herein, or described in U.S. Provisional Application No. 62/268,458, filed on Dec. 16, 2015, the entire contents of which is hereby incorporated by reference, or any other bulk metallic glass or other material or combination of materials suitable for use in a fused filament fabrication process as contemplated herein. For example, the build material 102 may also or instead include an off-eutectic composition or a peritectic composition. In another aspect, the build material 102 may include a composite material having a metallic base that melts at a first temperature and a high-temperature second phase that remains inert at temperatures above the first temperature as described for example in U.S. application Ser. No. 15/059,256 filed on Mar. 2, 2016 and incorporated by reference herein in its entirety. The build material 102 may also or instead include a range of other materials or composites such as thermoplastics loaded with metal that can be extruded into a net shape and then sintered into a final, metallic part such as powdered metallurgy materials or any other combination of a metal powder and a binder system formed of, e.g., a thermoplastic, a wax, a compatibilizer, a plasticizer, or some combination of these. Other metal-loaded extrudable compositions are described by way of non-limiting example in U.S. App. No. 62/434,014 filed on Dec. 14, 2016 and incorporated herein by reference, any of which may be suitably employed as a build material as contemplated herein.

In the context of this description, it will be understood that the term “melt” and derivatives thereof, when used in reference to, e.g., a melt temperature for a metallic build material or a process for melting the metallic build material, may refer to a specific temperature such as the melt temperature for a pure alloy, or a range of temperatures—typically a small range of temperatures—where a non-ideal alloy or material with minor contaminants or additional metals exists in a multi-phase solid and liquid state. Stated otherwise, the melt temperature in this context may be a temperature above which substantially all of the metallic build material is in a liquid state, and/or below which substantially all of the metallic build material is in a solid state. In other instances, such as off-eutectic compositions, the alloy may exhibit a wider range of temperatures where the material has two concurrent phases forming a slurry with rheological properties suitable for extrusion. These off-eutectics may nonetheless have a melt temperature above which they are substantially completely liquid, but the transition to a solid occurs over a wider temperature range within which, at equilibrium, a temperature-dependent percentage of the material is in a solid state (and a corresponding liquid state).

The build material 102 may be provided in a variety of form factors including, without limitation, any of the form factors described herein or in materials incorporated by reference herein. The build material 102 may be provided, for example, from a hermetically sealed container or the like (e.g., to mitigate passivation), as a continuous feed (e.g., a wire), or as discrete objects such as rods or rectangular prisms that can be fed into a chamber or the like as each prior discrete unit of build material 102 is heated and extruded. In one aspect, the build material 102 may include an additive such as fibers of carbon, glass, Kevlar, boron silica, graphite, quartz, or any other material that can enhance tensile strength of an extruded line of material. In one aspect, the additive(s) may be used to increase strength of a printed object. In another aspect, the additive(s) may be used to extend bridging capabilities by maintaining a structural path between the nozzle and a cooled, rigid portion of an object being fabricated. In one aspect, two build materials 102 may be used concurrently, e.g., through two different nozzles, where one nozzle is used for general fabrication and another nozzle is used for bridging, supports, or similar features.

The build material 102 may include a metal wire, such as a wire with a diameter of approximately 80 μm, 90 μm, 100 μm, 0.5 mm, 1 mm, 1.5 mm, 2 mm, 2.5 mm, 3 mm, or any other suitable diameter. Rods of build material 102 may also or instead be used, e.g., with wider diameters such as 8 mm, 9 mm, 10 mm, or any other suitable diameter. In another aspect, the build material 102 may be a metal powder, which may be loaded into a binder system for heating and extruding using the techniques contemplated herein. This latter technique may, for example, be particularly useful for fabricating green parts that can be subsequently debound and sintered into a final metal part.

The build material 102 may have any shape or size suitable for extrusion in a fused filament fabrication process. For example, the build material 102 may be in pellet or particulate form for heating and compression, or the build material 102 may be formed as a wire (e.g., on a spool), a billet, or the like for feeding into an extrusion process. More generally, any geometry that might be suitably employed for heating and extrusion might be used as a form factor for a build material 102 as contemplated herein. This may include loose bulk shapes such as spherical, ellipsoid, or flaked particles, as well as continuous feed shapes such as rods, wires, filaments or the like. Where particulates are used, a particulate can have any size useful for heating and extrusion. For example, particles may have an average diameter of between about 1 micron and about 100 microns, such as between about 5 microns and about 80 microns, between about 10 microns and about 60 microns, between about 15 microns and about 50 microns, between about 15 microns and about 45 microns, between about 20 microns and about 40 microns, or between about 25 microns and about 35 microns. For example, in one embodiment, the average diameter of the particulate is between about 25 microns and about 44 microns. In some embodiments, smaller particles, such as those in the nanometer range, or larger particle, such as those bigger than 100 microns, can also or instead be used.

As described herein, the build material 102 may include metal. By way of non-limiting example, the metal may include aluminum, such as elemental aluminum, an aluminum alloy, or an aluminum composite containing non-metallic materials such as ceramics or oxides. The metal may also or instead include iron. For example, the metal may include a ferrous alloy such as steel, stainless steel, or some other suitable alloy. The metal may also or instead include gold, silver, or alloys of the same. The metal may also or instead include one or more of a superalloy, nickel (e.g., a nickel alloy), titanium (e.g., a titanium alloy), and the like. More generally, any metal suitable for fabricating objects as contemplated herein may also or instead be employed.

The term metal, as used herein, may encompass both homogeneous metal compositions and alloys thereof, as well as additional materials such as modifiers, fillers, colorants, stabilizers, strengtheners and the like. For instance, in some implementations, a non-metallic material (e.g., plastic, glass, carbon fiber, and so forth) may be imbedded as a support material to reinforce structural integrity of a metallic build material. A non-metallic additive to an amorphous metal may be selected based on a melting temperature that is matched to a glass transition temperature or other lower viscosity temperature (e.g., a temperature between the glass transition temperature and melting temperature) of the amorphous metal. The presence of a non-metallic support material may be advantageous in many fabrication contexts, such as extended bridging where build material is positioned over large unsupported regions. Moreover, other non-metallic compositions such as sacrificial support materials may be usefully deposited using the systems and methods contemplated herein. Thus, for example, water soluble support structures having high melting temperatures, which are matched to the temperature range (i.e., between the glass transition temperature and melting temperature) of the metallic build material can be included within the printed product. All such materials and compositions used in fabricating a metallic object, either as constituents of the metallic object or as supplemental materials used to aid in the fabrication of the metallic object, are intended to fall within the scope of a metallic build material as contemplated herein.

A printer 101 disclosed herein may include a first nozzle for extruding a first material. The printer 101 may also include a second nozzle for extruding a second material, where the second material has a supplemental function (e.g., as a support material or structure) or provides a second build material with different mechanical, functional, or aesthetic properties useful for fabricating a multi-material object. The second material may be reinforced, for example, with an additive such that the second material has sufficient tensile strength or rigidity at an extrusion temperature to maintain a structural path between the second nozzle and a solidified portion of an object during an unsupported bridging operation. Other materials may also or instead be used as a second material. For example, this may include thermally matched polymers for fill, support, separation layers, or the like. In another aspect, this may include support materials such as water-soluble support materials with high melting temperatures at or near the window for extruding the first material. Useful dissolvable materials may include a salt or any other water soluble material(s) with suitable thermal and mechanical properties for extrusion as contemplated herein. While a printer 101 may usefully include two nozzles, it will be understood that the printer 101 may more generally incorporate any practical number of nozzles, such as three or four nozzles, according to the number of materials necessary or useful for a particular fabrication process.

In an aspect, the build material 102 may be fed (one by one) as billets or other discrete units into an intermediate chamber for delivery into the build chamber 116 and subsequent heating and deposition. The build material 102 may also or instead be provided in a cartridge or the like with a vacuum environment that can be directly or indirectly coupled to a vacuum environment of the build chamber 116. In another aspect, a continuous feed of the build material 102, e.g., a wire or the like, may be fed through a vacuum gasket into the build chamber 116 in a continuous fashion, where the vacuum gasket (or any similar fluidic seal) permits entry of the build material 102 into the chamber 116 while maintaining a controlled build environment inside the chamber 116.

While the following description emphasizes metallic build materials, many of the following methods and systems are also useful in the context of other types of materials. Thus, the term “build material” as used herein should be understood to include other additive fabrication materials, and in particular additive fabrication materials suitable for fused filament fabrication. This may for example include a thermoplastic such as acrylonitrile butadiene styrene (ABS), polylactic acid (PLA), polyether ether ketone (PEEK) or any other suitable polymer or the like. In another aspect, the build material 102 may include a binder system of a wax, a thermoplastic, a compatibilizer, a plasticizer, or some combination of these loaded with a metallic powder or the like suitable for fused filament fabrication of green parts that can be debound and sintered into a final, metallic object. Other sinterable powders such as ceramic powders or combinations of ceramic and metallic powders may be similarly loaded into a binder system for extrusion as a build material. All such materials are intended to fall within the scope of the term “build material” unless a different meaning is explicitly state or otherwise clear from the context.

A drive system 104 may include any suitable gears, compression pistons, or the like for continuous or indexed feeding of the build material 102 into the heating system 106. In one aspect, the drive system 104 may include a gear such as a spur gear with teeth shaped to mesh with corresponding features in the build material such as ridges, notches, or other positive or negative detents. In another aspect, the drive system 104 may use heated gears or screw mechanisms to deform and engage with the build material. Thus, in one aspect a printer for a metal FFF process may heat a metal to a temperature within a working temperature range for extrusion, and heat a gear that engages with, deforms, and drives the metal in a feed path toward the nozzle 110. In another aspect, the drive system 104 may include multiple stages. In a first stage, the drive system 104 may heat the material and form threads or other features that can supply positive gripping traction into the material. In the next stage, a gear or the like matching these features can be used to advance the build material along the feed path.

In another aspect, the drive system 104 may use bellows or any other collapsible or telescoping press to drive rods, billets, or similar units of build material into the heating system 106. Similarly, a piezoelectric or linear stepper drive may be used to advance a unit of build media in an indexed fashion using discrete mechanical increments of advancement in a non-continuous sequence of steps.

The heating system 106 may employ a variety of techniques to heat a metallic build material to a temperature within a working temperature range suitable for extrusion. For fused filament fabrication systems as contemplated herein, this is more generally a range of temperatures where a build material exhibits rheological properties suitable for fused filament fabrication or a similar extrusion-based process. These properties are generally appreciated for, e.g., thermoplastics such as ABS or PLA used in fused deposition modeling, however many metallic build materials have similarly suitable properties, albeit many with greater forces and higher temperatures, for heating, deformation and flow through a nozzle so that they can be deposited onto an object with a force and at a temperature to fuse to an underlying layer. Among other things, this requires a plasticity at elevated temperatures that can be propelled through a nozzle for deposition (at time scales suitable for three-dimensional printing), and a rigidity at lower temperatures that can be used to transfer force downstream in a feedpath to a reservoir where the build material can be heated into a flowable state and forced out of a nozzle.

This working temperature range may vary according to the type of build material 102 being heated by the heating system 106. For example, where the build material 102 includes a bulk metallic glass, the working temperature range may include a temperature above a glass transition temperature for the bulk metallic glass and below a melting temperature for the bulk metallic glass. The use of bulk metallic glasses may also be constrained by a time-temperature-transformation curve that characterizes the onset of crystallization as the material is maintained at elevated temperatures. Where the build material 102 includes an off-eutectic composition of eutectic systems, the working temperature range may include a range of temperatures above a lowest melting temperature of the off-eutectic system and below a highest melting temperature of the off-eutectic system. The build material 102 may also or instead include a composite material having a metallic base that melts at a first temperature and a high-temperature inert second phase in particle form that remains inert up to at least a second temperature greater than the first temperature. For this type of material, the working temperature range may include a range of temperatures above a melting point of the metallic base and below a reaction or dissolution temperature of the inert second phase. In another aspect, the build material 102 may include a peritectic composition and the working temperature range may include any range of temperatures where the peritectic composition exhibits a substantial volume fraction of both a solid and a liquid.

Any heating system 106 or combination of heating systems suitable for maintaining a corresponding working temperature range in the build material 102 where and as needed to drive the build material 102 to and through the nozzle 110 may be suitably employed as a heating system 106 as contemplated herein. In one aspect, electrical techniques such as inductive or resistive heating may be usefully applied to heat the build material 102. Thus, for example, the heating system 106 may an inductive heating system or a resistive heating system configured to electrically heat a chamber around the build material 102 to a temperature within the working temperature range, or this may include a heating system such as an inductive heating system or a resistive heating system configured to directly heat the material itself through an application of electrical energy. Because metallic build materials are generally conductive, they may be electrically heated through contact methods (e.g., resistive heating with applied current) or non-contact methods (e.g., induction heating using an external electromagnet to drive eddy currents within the material). When directly heating the build material 102, it may be useful to model the shape and size of the build material 102 in order to better control electrically-induced heating. This may include estimates or actual measurements of shape, size, mass, and so forth, as well as information about bulk electromagnetic properties of the build material 102. The heating system 106 may also include various supplemental systems for locally or globally augmenting heating using, e.g., chemical heating, combustion, laser heating or other optical heating, radiant heating, ultrasound heating, electronic beam heating, and so forth.

It will be appreciated that magnetic forces may also be used to assist a fabrication process as contemplated herein. For example, magnetic forces may be applied, in particular to ferrous metals, for exertion of force to control a path of the build material 102. This may be particularly useful in transitional scenarios such as where a BMG is heated above the melt temperature in order to promote crystallization at an interface between an object and a support structure. In these instances, magnetic forces might usefully supplement surface tension to retain a melted alloy within a desired region of a layer.

In order to facilitate resistive heating of the build material 102, one or more contact pads, probes, or the like may be positioned within the feed path for the material, e.g., on an interior of a nozzle or heating reservoir, in order to provide locations for forming a circuit through the material at the appropriate location(s). In order to facilitate induction heating, one or more electromagnets may be positioned at suitable locations adjacent to the feed path and operated, e.g., by the control system 118, to heat the build material 102 internally through the creation of eddy currents. In one aspect, both of these techniques may be used concurrently to achieve a more tightly controlled or more evenly distributed electrical heating within the build material 102. The printer 101 may also be instrumented to monitor the resulting heating in a variety of ways. For example, the printer 101 may monitor power delivered to the inductive or resistive circuits. The printer 101 may also or instead measure temperature of the build material 102 or surrounding environment at any number of locations.

In another aspect, the temperature of the build material 102 may be inferred by measuring, e.g., the amount of force required to drive the build material 102 through a nozzle 110 or other portion of the feed path. Where viscosity changes with temperature (e.g., where viscosity increases as temperature decreases), and where changes in viscosity cause changes in the driving force required for extrusion, the change in driving force may be used to estimate a temperature of the build material. A control loop may be usefully established on this basis to decrease an extrusion rate as driving force increases, specifically in order to increase heat transfer and raise a temperature of the build material 102. Conversely, the control loop may increase the extrusion rate or drive speed as the driving force decreases in order to decrease heat transfer from the heating system 106 and lower a temperature of the build material 102. This technique advantageously uses the force to measure temperature effectively instantaneously, or more generally measures a consequence of temperature change that is highly relevant to process control—a change the driving force (at least to the extent that the viscosity depends on the temperature). At the same time, this approach advantageously uses drive speed to control heating in a manner that can adjust heat more quickly than resistive heating elements or the like. By increasing both measurement speed and response speed in this manner, improved control of temperature during extrusion is possible. Thus, in one aspect, there is disclosed herein a force sensor configured to measure a force resisting advancement of the build material 102 (e.g., a metallic build material) along a feedpath through the nozzle 110, and a processor such as the control system 118 coupled to the force sensor and the drive system 104 and configured to adjust a speed of the drive system according to the force measured by the force sensor. It will be understood that the system may be instrumented in a variety of ways to measure the force required to drive the build material through an extruder, any of which may be usefully employed as a force sensor as contemplated herein. More generally, any techniques suitable for measuring temperature or viscosity of the build material 102 and responsively controlling applied electrical energy may be used to control liquefaction for a metal FFF process as contemplated herein.

In one aspect, the printer 101 may be augmented with a system for controlled delivery of amorphous metal powders that can be deposited in and around an object 112 during fabrication, or to form some or all of the object, and the powder can be sintered with a laser heating process that raises a temperature of the metal powder enough to bond with neighboring particles but not enough to recrystallize the material. This technique may be used, for example, to fabricate an entire object out of a powderized amorphous alloy, or this technique may be used to augment a fused filament fabrication process, e.g., by providing a mechanism to mechanically couple two or more objects fabricated within the build chamber, or to add features before, during, or after an independent fused filament fabrication process.

The heating system 106 may include a shearing engine. The shearing engine may create shear within the build material 102 as it is heated in order to prevent crystallization, e.g., of bulk metallic glasses or other metallic compositions being used at temperatures prone to partial solidification. For bulk metallic glasses, a shearing engine may be particularly useful when the heating approaches the melting temperature or the build material 102 is maintained at an elevated temperature for an extended period of time (relative to the time-temperature-transformation curve). A variety of techniques may be employed by the shearing engine. In one aspect, the bulk media may be axially rotated as it is fed along the feed path into the heating system 106. In another aspect, one or more ultrasonic transducers may be used to introduce shear within the heated material. Similarly, a screw, post, arm, or other physical element may be placed within the heated media and rotated or otherwise actuated to mix the heated material.

The robotics 108 may include any robotic components or systems suitable for moving the nozzles 110 in a three-dimensional path relative to the build plate 114 while extruding build material 102 in order to fabricate the object 112 from the build material 102 according to a computerized model of the object. A variety of robotics systems are known in the art and suitable for use as the robotics 108 contemplated herein. For example, the robotics 108 may include a Cartesian coordinate robot or x-y-z robotic system employing a number of linear controls to move independently in the x-axis, the y-axis, and the z-axis within the build chamber 116. Delta robots may also or instead be usefully employed, which can, if properly configured, provide significant advantages in terms of speed and stiffness, as well as offering the design convenience of fixed motors or drive elements. Other configurations such as double or triple delta robots can increase range of motion using multiple linkages. More generally, any robotics suitable for controlled positioning of a nozzle 110 relative to the build plate 114, especially within a vacuum or similar environment, may be usefully employed, including any mechanism or combination of mechanisms suitable for actuation, manipulation, locomotion, and the like within the build chamber 116.

The robotics 108 may position the nozzle 110 relative to the build plate 114 by controlling movement of one or more of the nozzle 110 and the build plate 114. For example, in an aspect, the nozzle 110 is operably coupled to the robotics 108 such that the robotics 108 position the nozzle 110 while the build plate 114 remains stationary. The build plate 114 may also or instead be operably coupled to the robotics 108 such that the robotics 108 position the build plate 114 while the nozzle remains stationary. Or some combination of these techniques may be employed, such as by moving the nozzle 110 up and down for z-axis control, and moving the build plate 114 within the x-y plane to provide x-axis and y-axis control. In some such implementations, the robotics 108 may translate the build plate 114 along one or more axes, and/or may rotate the build plate 114.

It will be understood that a variety of arrangements and techniques are known in the art to achieve controlled linear movement along one or more axes, and/or controlled rotational motion about one or more axes. The robotics 108 may, for example, include a number of stepper motors to independently control a position of the nozzle 110 or build plate 114 within the build chamber 116 along each axis, e.g., an x-axis, a y-axis, and a z-axis. More generally, the robotics 108 may include without limitation various combinations of stepper motors, encoded DC motors, gears, belts, pulleys, worm gears, threads, and the like. Any such arrangement suitable for controllably positioning the nozzle 110 or build plate 114 may be adapted for use with the additive manufacturing system 100 described herein.

The nozzles 110 may include one or more nozzles for extruding the build material 102 that has been propelled with the drive system 104 and heated with the heating system 106. The nozzles 110 may include a number of nozzles that extrude different types of material so that, for example, a first nozzle 110 extrudes a metallic build material while a second nozzle 110 extrudes a support material in order to support bridges, overhangs, and other structural features of the object 112 that would otherwise violate design rules for fabrication with the metallic build material. In another aspect, one of the nozzles 110 may deposit a material, such as a thermally compatible polymer and/or a material loaded with fibers to increase tensile strength or otherwise improve mechanical properties.

In one aspect, the nozzle 110 may include one or more ultrasound transducers 130 as described herein. Ultrasound may be usefully applied for a variety of purposes in this context. In one aspect, the ultrasound energy may facilitate extrusion by mitigating adhesion of a metal (e.g., a BMG) to interior surfaces of the nozzle 110. In another aspect, the ultrasonic energy can be used to break up a passivation layer on a prior layer of printed media for improved interlayer adhesion. Thus, in one aspect, a nozzle of a metal FFF printer may include an ultrasound transducer operable to improve extrusion through a nozzle by reducing adhesion to the nozzle while concurrently improving layer-to-layer bonding by breaking up a passivation layer on target media from a previous layer.

In another aspect, the nozzle 110 may include an induction heating element, resistive heating element, or similar components to directly control the temperature of the nozzle 110. This may be used to augment a general liquefaction process along the feed path through the printer 101, e.g., to maintain a temperature of the build material 102 in a working temperature range, or this may be used for more specific functions, such as de-clogging a print head by heating the build material 102 above Tₘ to melt the build material 102 into a liquid state. While it may be difficult or impossible to control deposition in this liquid state, the heating can provide a convenient technique to clear and reset the nozzle 110 without more severe physical intervention such as removing vacuum from a build chamber to disassemble, clean, and replace affected components.

In another aspect, the nozzle 110 may include an inlet gas, e.g., an inert gas, to cool media at the moment it exits the nozzle 110. More generally, the nozzle 110 may include any cooling system for applying a cooling fluid to a build material 102 as it exits the nozzle 110. This gas jet may, for example, immediately stiffen extruded material to facilitate extended bridging, larger overhangs, or other structures that might otherwise require support structures during fabrication.

In another aspect, the nozzle 110 may include one or more mechanisms to flatten a layer of deposited material and apply pressure to bond the layer to an underlying layer. For example, a heated nip roller, caster, or the like may follow the nozzle 110 in its path through an x-y plane of the build chamber 116 to flatten the deposited (and still pliable) layer. The nozzle 110 may also or instead integrate a forming wall, planar surface, or the like to additionally shape or constrain an extrudate as it is deposited by the nozzle 110. The nozzle 110 may usefully be coated with a non-stick material (which may vary according to the build material 102 being used) in order to facilitate more consistent shaping and smoothing by this tool.

In general, the nozzle 110 may include a reservoir, a heater (such as the heating system 106) configured to maintain a build material (e.g., a metal or metallic alloy) within the reservoir in a liquid or otherwise extrudable form, and an outlet. The components of the nozzle 110, e.g., the reservoir and the heater, may be contained within a housing or the like. In an aspect, the nozzle 110 may include a mechanical device, such as a valve, a plate with metering holes, or some other suitable mechanism to mechanically control build material 102 exiting the nozzle 110. The nozzle 110 or a portion thereof may be movable within the build chamber 116 by the robotics 108 (e.g., a robotic positioning assembly) relative to the build plate 114. For example, the nozzle 110 may be movable by the robotics 108 along a tool path while depositing a build material (e.g., a liquid metal) to form the object 112, or the build plate 114 may move within the build chamber 116 while the nozzle 110 remains stationary, or some combination of these.

Where the printer 101 includes multiple nozzles 110, a second nozzle may usefully provide any of a variety of additional build materials. This may, for example, include other metals with different or similar thermal characteristics (e.g., T_{g}, Tₘ), thermally matched polymers to support multi-material printing, support materials, interface materials for forming breakaway supports, dissolvable materials, and so forth. In one aspect, two or more nozzles 110 may provide two or more different bulk metallic glasses with different super-cooled liquid regions. The material with the lower super cooled liquid region can be used as a support material and the material with the higher temperature region can be formed into the object 112. In this manner, the deposition of the higher temperature material (in the object 112) onto an underlying layer of the lower temperature support material can cause the lower temperature material to melt and/or crystallize at the interface between the two as deposition occurs, rendering the interface brittle and relatively easy to remove with the application of mechanical force. Conveniently, the bulk form of the underlying support structure will not generally become crystallized due to this application of surface heating, so the support structure can retain full strength throughout its bulk form for removal as a single piece from the embrittled interface. The control system 118 may be configured to control the location and temperature of these different build materials 102 to create an inherently brittle interface layer between a support structure 113 and an object 112. Thus, in one aspect, there is disclosed herein a printer that fabricates a layer of a support structure using a first bulk metallic glass with a first super cooled liquid region, and that fabricates a layer of an object on top of the layer of the support structure using a second bulk metallic glass with a second super-cooled liquid region having a minimum temperature and/or temperature range greater than the first super-cooled liquid region.

Thus, as described above, in some implementations, a three-dimensional printer 101 may include a second nozzle 110 that extrudes a second bulk metallic glass. A second nozzle 110 may also be used to extrude any number of other useful materials such as a wax, a second metal dissimilar from a first material used in a first nozzle, a polymer, a ceramic, or some other material for providing support, weakening an interface to a support structure, or otherwise imparting desired properties onto an object and related support structures. The control system 118 may, for example, be configured to operate the first and second nozzles simultaneously, independently of one other, or in some other suitable fashion to generate layers that include the first material, the second material, or both.

The object 112 may be any object suitable for fabrication using the techniques contemplated herein. This may include functional objects such as machine parts, aesthetic objects such as sculptures, or any other type of objects, as well as combinations of objects that can be fit within the physical constraints of the build chamber 116 and build plate 114. Some structures such as large bridges and overhangs cannot be fabricated directly using FFF because there is no underlying physical surface onto which a material can be deposited. In these instances, a support structure 113 may be fabricated, preferably of a soluble or otherwise readily removable material, in order to support a corresponding feature.

The build plate 114 may be formed of any surface or substance suitable for receiving deposited metal or other materials from the nozzles 110. The surface of the build plate 114 may be rigid and substantially planar. In one aspect, the build plate 114 may be heated, e.g., resistively or inductively, to control a temperature of the build chamber 116 or a surface upon which the object 112 is being fabricated. This may, for example, improve adhesion, prevent thermally induced deformation or failure, and facilitate relaxation of stresses within the fabricated object. In another aspect, the build plate 114 may be a deformable structure or surface that can bend or otherwise physically deform in order to detach from a rigid object 112 formed thereon. The build plate 114 may also include electrical contacts providing a circuit path for internal ohmic heating of the object 112 or heating an interface between the object 112 and build material 102 exiting the nozzle 110.

The build plate 114 may be movable within the build chamber 116, e.g., by a positioning assembly (e.g., the same robotics 108 that position the nozzle 110 or different robotics). For example, the build plate 114 may be movable along a z-axis (e.g., up and down—toward and away from the nozzle 110), or along an x-y plane (e.g., side to side, for instance in a pattern that forms the tool path or that works in conjunction with movement of the nozzle 110 to form the tool path for fabricating the object 112), or some combination of these. In an aspect, the build plate 114 is rotatable.

The build plate 114 may include a temperature control system for maintaining or adjusting a temperature of at least a portion of the build plate 114. The temperature control system may be wholly or partially embedded within the build plate 114. The temperature control system may include without limitation one or more of a heater, coolant, a fan, a blower, or the like. In implementations, temperature may be controlled by induction heating of the metallic printed part.

In one aspect, a coating 115 may be provided on the build plate 114 formed of a material having a melt temperature below a bottom of a working temperature range for a build material 102 (and/or support material of a support structure 113) extruded by the nozzle 110. This coating 115 may be cooled into a solid form, e.g. with a cooling system 117 for the build plate 114, which may employ Peltier cooling, liquid cooling, gas cooling, or any other suitable technique or combination of techniques to maintain the coating 115 in a solid state as a heated build material is deposited thereon. In particular, the cooling system 117 may be configured to maintain the material of the coating 115 at a temperature below the melt temperature of the coating 115 during fabrication of an object 112 from the build material 102 on the build plate 114. Similarly, the heating system 106 of the printer may specifically include a heating system 106 for the build plate 114 configured to heat the material of the coating 115 on the build plate 114 above the melt temperature of the coating 115 to permit removal of an object 112 from the build plate 114 after fabrication has been completed. This may facilitate removal of the object 112 without deforming the object 112 by heating the material of the coating 115 on the build plate 114 to a temperature that is concurrently above the melt temperature for the coating and below a bottom of the working temperature range for the build material 102 used to fabricate the object 112.

Suitable coatings 115 for use with metallic build materials may, for example, include a low-melt-temperature solder such as a solder alloy containing bismuth or indium. In another aspect, the coating 115 may usefully be formed of a material that is non-reactive with the build material 102 when molten so that the coating 115 does not diffuse into or otherwise contaminate the surface of the object 112. Useful alloys with generally low reactivity may include alloys of lead with iron, lead with aluminum alloys, tin with aluminum alloys, or any alloy saturated with components of the build material 102 (or support material, where appropriate) so that they are effectively immiscible.

In general, the build chamber 116 houses the build plate 114 and the nozzle 110, and maintains a build environment suitable for fabricating the object 112 on the build plate 114 from the build material 102. Where appropriate for the build material 102, this may include a vacuum environment, an oxygen depleted environment, a heated environment, and inert gas environment, and so forth. The build chamber 116 may be any chamber suitable for containing the build plate 114, an object 112, and any other components of the printer 101 used within the build chamber 116 to fabricate the object 112.

The printer 101 may include a vacuum pump 124 coupled to the build chamber 116 and operable to create a vacuum within the build chamber 116. A number of suitable vacuum pumps are known in the art and may be adapted for use as the vacuum pump 124 contemplated herein. The build chamber 116 may from an environmentally sealed chamber so that it can be evacuated with the vacuum pump 124 or any similar device in order to provide a vacuum environment for fabrication. This may be particularly useful where oxygen causes a passivation layer that might weaken layer-to-layer bonds in a fused filament fabrication process as contemplated herein. The build chamber 116 may be hermetically sealed, air-tight, or otherwise environmentally sealed. The environmentally sealed build chamber 116 can be purged of oxygen, or filled with one or more inert gases in a controlled manner to provide a stable build environment. Thus, for example, the build chamber 116 may be substantially filled with one or more inert gases such as argon or any other gases that do not interact significantly with heated metallic build materials 102 used by the printer 101. The environmental sealing may include thermal sealing, e.g., to prevent an excess of heat transfer from heated components within the build volume to an external environment, and vice-versa. The seal of the build chamber 116 may also or instead include a pressure seal to facilitate pressurization of the build chamber 116, e.g., to provide a positive pressure that resists infiltration by surrounding oxygen and other ambient gases or the like. To maintain the seal of the build chamber 116, any openings in an enclosure of the build chamber 116, e.g., for build material feeds, electronics, and so on, may include suitably corresponding vacuum seals or the like.

In some implementations, an environmental control element such as an oxygen getter may be included within the support structure material to provide localized removal of oxygen or other gases. Where external ventilation is needed to maintain a suitable build environment, an air filter such as a charcoal filter may usefully be employed to filter gases that are exiting the build chamber 116.

One or more passive or active oxygen getters 126 or other similar oxygen absorbing materials or systems may usefully be employed within the build chamber 116 to take up free oxygen. The oxygen getter 126 may, for example, include a deposit of a reactive material that coats an inside surface of the build chamber 116, or a separate object placed within the build chamber 116 that improves or maintains the vacuum by combining with or adsorbing residual gas molecules. In one aspect, the oxygen getters 126 may include any of a variety of materials that preferentially react with oxygen including, e.g., materials based on titanium, aluminum, and so forth. In another aspect, the oxygen getters 126 may include a chemical energy source such as a combustible gas, gas torch, catalytic heater, Bunsen burner, or other chemical and/or combustion source that reacts to extract oxygen from the environment. There are a variety of low-CO and NOx catalytic burners that may be suitably employed for this purpose without outputting potentially harmful CO. The oxygen getters 126 may also or instead include an oxygen filter, an electrochemical oxygen pump, a cover gas supply, an air circulator, and the like. Thus, in implementations, purging the build chamber 116 of oxygen may include one or more of applying a vacuum to the build chamber 116, supplying an inert gas to the build chamber 116, placing an oxygen getter 126 inside the build chamber 116, applying an electrochemical oxygen pump to the build chamber 116, cycling the air inside the build chamber 116 through an oxygen filter (e.g., a porous ceramic filter), and the like.

In one aspect, the oxygen getters 126, or more generally, gas getters, may be deposited as a support material using one of the nozzles 110, which facilitates replacement of the gas getter with each new fabrication run and can advantageously position the gas getter(s) near printed media in order to more locally remove passivating gases where new material is being deposited onto the fabricated object. The oxygen getter 126 may also or instead be deposited as a separate material during a build process. Thus, in one aspect, there is disclosed herein a process for fabricating a three-dimensional object from a metal including co-fabricating a physically adjacent structure (which may or may not directly contact the three-dimensional object) containing an agent to remove passivating gases around the three-dimensional object. Other techniques may be similarly employed to control reactivity of the environment within the build chamber 116. For example, the build chamber 116 may be filled with an inert gas or the like to prevent oxidation.

The build chamber 116 may include a temperature control system 128 for maintaining or adjusting a temperature of at least a portion of a volume of the build chamber 116 (e.g., the build volume). The temperature control system 128 may include without limitation one or more of a heater, a coolant, a fan, a blower, or the like. The temperature control system 128 may use a fluid or the like as a heat exchange medium for transferring heat as desired within the build chamber 116. The temperature control system 128 may also or instead move air (e.g., circulate air) within the build chamber 116 to control temperature, to provide a more uniform temperature, or to transfer heat within the build chamber 116.

The temperature control system 128, or any of the temperature control systems described herein (e.g., a temperature control system of the heating system 106 or a temperature control system of the build plate 114) may include one or more active devices such as resistive elements that convert electrical current into heat, Peltier effect devices that heat or cool in response to an applied current, or any other thermoelectric heating and/or cooling devices. Thus, the temperature control systems discussed herein may include a heater that provides active heating to the components of the printer 101, a cooling element that provides active cooling to the components of the printer 101, or a combination of these. The temperature control systems may be coupled in a communicating relationship with the control system 118 in order for the control system 118 to controllably impart heat to or remove heat from the components of the printer 101. Thus, the temperature control system 128 may include an active cooling element positioned within or adjacent to the components of the printer 101 to controllably cool the components of the printer 101. In another aspect, the temperature control system 128 may include any combination of heating and cooling systems suitable for controllably melting and solidifying a low-melt-temperature solder or other coating on the build plate 114 to controllably secure and release a fabricated object and/or support structure to the build plate 114. It will be understood that a variety of other techniques may be employed to control a temperature of the components of the printer 101. For example, the temperature control systems may use a gas cooling or gas heating device such as a vacuum chamber or the like in an interior thereof, which may be quickly pressurized to heat the components of the printer 101 or vacated to cool the components of the printer 101 as desired. As another example, a stream of heated or cooled gas may be applied directly to the components of the printer 101 before, during, and/or after a build process. Any device or combination of devices suitable for controlling a temperature of the components of the printer 101 may be adapted to use as the temperature control systems described herein.

It will be further understood that the temperature control system 128 for the build chamber 116, the temperature control system of the heating system 106, and the temperature control system of the build plate 114, may be included in a singular temperature control system (e.g., included as part of the control system 118 or otherwise in communication with the control system 118) or they may be separate and independent temperature control systems. Thus, for example, a heated build plate or a heated nozzle may contribute to heating of the build chamber 116 and form a component of a temperature control system 128 for the build chamber 116.

The build chamber 116 may also or instead include a pressure control system for maintaining or adjusting a pressure of at least a portion of a volume of the build chamber 116, for example by increasing the pressure relative to an ambient pressure to provide a pressurized build chamber 116, or decreasing the pressure relative to an ambient pressure to provide a vacuum build chamber 116. As described above a vacuum build chamber 116 may usefully integrate oxygen getters or other features to assist in depleting gases from the build chamber 116. Similarly, where a pressurized build chamber 116 is used, the build chamber 116 may be filled and pressurized with an inert gas or the like to provide a controlled environment for fabrication.

Objects fabricated from metal may be relatively heavy and difficult to handle. To address this issue, a scissor table or other lifting mechanism may be provided to lift fabricated objects out of the build chamber 116. An intermediate chamber may usefully be employed for transfers of printed objects out of the build chamber 116, particularly where the build chamber 116 maintains a highly heated, pressurized or depressurized environment, or in any other processing environment generally incompatible with direct exposure to an ambient environment.

In general, a control system 118 may include a controller or the like configured to control operation of the printer 101. The control system 118 may be operable to control the components of the additive manufacturing system 100, such as the nozzle 110, the build plate 114, the robotics 108, the various temperature and pressure control systems, and any other components of the additive manufacturing system 100 described herein to fabricate the object 112 from the build material 102 based on a three-dimensional model 122 or any other computerized model describing the object 112. The control system 118 may include any combination of software and/or processing circuitry suitable for controlling the various components of the additive manufacturing system 100 described herein including without limitation microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and the like. In one aspect, the control system 118 may include a microprocessor or other processing circuitry with sufficient computational power to provide related functions such as executing an operating system, providing a graphical user interface (e.g., to a display coupled to the control system 118 or printer 101), converting three-dimensional models 122 into tool instructions, and operating a web server or otherwise hosting remote users and/or activity through a network interface 162 for communication through a network 160.

The control system 118 may include a processor and memory, as well as any other co-processors, signal processors, inputs and outputs, digital-to-analog or analog-to-digital converters, and other processing circuitry useful for controlling and/or monitoring a fabrication process executing on the printer 101, e.g., by providing instructions to control operation of the printer 101. To this end, the control system 118 may be coupled in a communicating relationship with a supply of the build material 102, the drive system 104, the heating system 106, the nozzles 110, the build plate 114, the robotics 108, and any other instrumentation or control components associated with the build process such as temperature sensors, pressure sensors, oxygen sensors, vacuum pumps, and so forth.

The control system 118 may generate machine-ready code for execution by the printer 101 to fabricate the object 112 from the three-dimensional model 122. In another aspect, the machine-ready code may be generated by an independent computing device 164 based on the three-dimensional model 122 and communicated to the control system 118 through a network 160, which may include a local area network or an internetwork such as the Internet, and the control system 118 may interpret the machine-ready code and generate corresponding control signals to components of the printer 101. The control system 118 may deploy a number of strategies to improve the resulting physical object structurally or aesthetically. For example, the control system 118 may use plowing, ironing, planing, or similar techniques where the nozzle 110 is run over existing layers of deposited material, e.g., to level the material, remove passivation layers, or otherwise prepare the current layer for a next layer of material and/or shape and trim the material into a final form. The nozzle 110 may include a non-stick surface to facilitate this plowing process, and the nozzle 110 may be heated and/or vibrated (using the ultrasound transducer) to improve the smoothing effect. In one aspect, these surface preparation steps may be incorporated into the initially-generated machine ready code such as g-code derived from a three-dimensional model and used to operate the printer 101 during fabrication. In another aspect, the printer 101 may dynamically monitor deposited layers and determine, on a layer-by-layer basis, whether additional surface preparation is necessary or helpful for successful completion of the object 112. Thus, in one aspect, there is disclosed herein a printer 101 that monitors a metal FFF process and deploys a surface preparation step with a heated or vibrating non-stick nozzle when a prior layer of the metal material is unsuitable for receiving additional metal material.

The printer 101 may measure pressure or flow rate for the nozzle 110, and the control system 118 may employ a corresponding signal as a process feedback signal. While temperature may be a critical physical quantity for a metal build, it may be difficult to accurately measure the temperature of metal throughout the feed path during a metal FFF process. However, the temperature can often be inferred by the viscosity of the build material 102, which can be easily measured for bulk material based on how much work is being done to drive the material along a feed path. Thus, in one aspect, there is disclosed herein a printer 101 that measures a force applied to a metallic build material by a drive system 104 or the like, infers a temperature of the build material 102 based on the force (e.g., instantaneous force), and controls a heating system 106 to adjust the temperature accordingly. As noted above, the control system 118 may also or instead adjust an extrusion speed as an expedient for controlling heat transfer from the heating system 106 to the build material 102.

In another aspect, the control system 118 may control deposition parameters to modify the physical interface between support materials and an object 112. While a support structure 113 is typically formed from a material different from the build material for the object 112, such as a soluble material or a softer or more brittle material, the properties of a bulk metallic glass can be modified to achieve similarly useful results using the same print media. For example, the pressure applied by the nozzle 110, the temperature of liquefaction, or any other temperature-related process parameters may be controlled, either throughout the support structure 113 or specifically at the interface between the object 112 and the support structure 113, to change the mechanical properties of a bulk metallic glass. As a more specific example, a layer may be fabricated at a temperature near or above the melting temperature in order to cause melt and/or crystallization, resulting in a more brittle structure at the interface. Thus, in one aspect, there is disclosed herein a technique for fabricating an object 112 including fabricating a support structure 113 from a build material 102 that includes a bulk metallic glass, fabricating a top layer of the support structure 113 (or a bottom layer of the object 112) at a temperature sufficient to induce crystallization of the build material 102, and fabricating a bottom layer of an object 112 onto the top layer of the support structure 113 at a temperature between a glass transition temperature and a melting temperature. In another aspect, a passivating layer may be induced to reduce the strength of the bond between the support layer and the object layer, such as by permitting or encouraging oxidation between layers.

In general, a three-dimensional model 122 or other computerized model of the object 112 may be stored in a database 120 such as a local memory of a computing device used as the control system 118, or a remote database accessible through a server or other remote resource, or in any other computer-readable medium accessible to the control system 118. The control system 118 may retrieve a particular three-dimensional model 122 in response to user input, and generate machine-ready instructions for execution by the printer 101 to fabricate the corresponding object 112. This may include the creation of intermediate models, such as where a CAD model is converted into an STL model, or other polygonal mesh or other intermediate representation, which can in turn be processed to generate machine instructions such as g-code for fabrication of the object 112 by the printer 101.

In operation, to prepare for the additive manufacturing of an object 112, a design for the object 112 may first be provided to a computing device 164. The design may be a three-dimensional model 122 included in a CAD file or the like. The computing device 164 may in general include any devices operated autonomously or by users to manage, monitor, communicate with, or otherwise interact with other components in the additive manufacturing system 100. This may include desktop computers, laptop computers, network computers, tablets, smart phones, smart watches, or any other computing device that can participate in the system as contemplated herein. In one aspect, the computing device 164 is integral with the printer 101.

The computing device 164 may include the control system 118 as described herein or a component of the control system 118. The computing device 164 may also or instead supplement or be provided in lieu of the control system 118. Thus, unless explicitly stated to the contrary or otherwise clear from the context, any of the functions of the computing device 164 may be performed by the control system 118 and vice-versa. In another aspect, the computing device 164 is in communication with or otherwise coupled to the control system 118, e.g., through a network 160, which may be a local area network that locally couples the computing device 164 to the control system 118 of the printer 101, or an internetwork such as the Internet that remotely couples the computing device 164 in a communicating relationship with the control system 118.

The computing device 164 (and the control system 118) may include a processor 166 and a memory 168 to perform the functions and processing tasks related to management of the additive manufacturing system 100 as described herein. In general, the memory 168 may contain computer code that can be executed by the processor 166 to perform the various steps described herein, and the memory may further store data such as sensor data and the like generated by other components of the additive manufacturing system 100.

One or more ultrasound transducers 130 or similar vibration components may be usefully deployed at a variety of locations within the printer 101. For example, a vibrating transducer may be used to vibrate pellets, particles, or other similar media as it is distributed from a hopper of build material 102 into the drive system 104. Where the drive system 104 includes a screw drive or similar mechanism, ultrasonic agitation in this manner can more uniformly distribute pellets to prevent jamming or inconsistent feeding.

In another aspect, an ultrasonic transducer 130 may be used to encourage a relatively high-viscosity metal media such as a heated bulk metallic glass to deform and extrude through a pressurized die at a hot end of the nozzle 110. One or more dampers, mechanical decouplers, or the like may be included between the nozzle 110 and other components in order to isolate the resulting vibration within the nozzle 110.

During fabrication, detailed data may be gathered for subsequent use and analysis. This may, for example, include data from a sensor and computer vision system that identifies errors, variations, or the like that occur in each layer of an object 112. Similarly, tomography or the like may be used to detect and measure layer-to-layer interfaces, aggregate part dimensions, and so forth. This data may be gathered and delivered with the object to an end user as a digital twin 140 of the object 112, e.g., so that the end user can evaluate how variations and defects might affect use of the object 112. In addition to spatial/geometric analysis, the digital twin 140 may log process parameters including, e.g., aggregate statistics such as weight of material used, time of print, variance of build chamber temperature, and so forth, as well as chronological logs of any process parameters of interest such as volumetric deposition rate, material temperature, environment temperature, and so forth.

The digital twin 140 may also usefully log a thermal history of the build material 102, e.g., on a voxel-by-voxel or other volumetric basis within the completed object 112. Thus, in one aspect, the digital twin 140 may store a spatial temporal map of thermal history for build material that is incorporated into the object 112, which may be used, e.g., in order to estimate a crystallization state of bulk metallic glass within the object 112 and, where appropriate, initiate remedial action during fabrication. The control system 118 may use this information during fabrication, and may be configured to adjust a thermal parameter of a fused filament fabrication system or the like during fabrication according to the spatial temporal map of thermal history. For example, the control system 118 may usefully cool a build chamber or lower an extrusion temperature where a bulk metallic glass is approaching crystallization.

The printer 101 may include a camera 150 or other optical device. In one aspect, the camera 150 may be used to create the digital twin 140 or provide spatial data for the digital twin 140. The camera 150 may more generally facilitate machine vision functions or facilitate remote monitoring of a fabrication process. Video or still images from the camera 150 may also or instead be used to dynamically correct a print process, or to visualize where and how automated or manual adjustments should be made, e.g., where an actual printer output is deviating from an expected output. The camera 150 can be used to verify a position of the nozzle 110 and/or build plate 114 prior to operation. In general, the camera 150 may be positioned within the build chamber 116, or positioned external to the build chamber 116, e.g., where the camera 150 is aligned with a viewing window formed within a chamber wall.

The additive manufacturing system 100 may include one or more sensors 170. The sensor 170 may communicate with the control system 118, e.g., through a wired or wireless connection (e.g., through a data network 160). The sensor 170 may be configured to detect progress of fabrication of the object 112, and to send a signal to the control system 118 where the signal includes data characterizing progress of fabrication of the object 112. The control system 118 may be configured to receive the signal, and to adjust at least one parameter of the additive manufacturing system 100 in response to the detected progress of fabrication of the object 112.

The one or more sensors 170 may include without limitation one or more of a contact profilometer, a non-contact profilometer, an optical sensor, a laser, a temperature sensor, motion sensors, an imaging device, a camera, an encoder, an infrared detector, a volume flow rate sensor, a weight sensor, a sound sensor, a light sensor, a sensor to detect a presence (or absence) of an object, and so on.

As discussed herein, the control system 118 may adjust a parameter of the additive manufacturing system 100 in response to the sensor 170. The adjusted parameter may include a temperature of the build material 102, a temperature of the build chamber 116 (or a portion of a volume of the build chamber 116), and a temperature of the build plate 114. The parameter may also or instead include a pressure such as an atmospheric pressure within the build chamber 116. The parameter may also or instead include an amount or concentration of an additive for mixing with the build material such as a strengthening additive, a colorant, an embrittlement material, and so forth.

In some implementations, the control system 118 may (in conjunction with one or more sensors 170) identify the build material 102 used in the additive manufacturing system 100, and may in turn adjust a parameter of the additive manufacturing system 100 based on the identification of the build material 102. For example, the control system 118 may adjust a temperature of the build material 102, an actuation of the nozzle 110, a position of one or more of the build plate 114 and the nozzle 110 via the robotics 108, a volume flow rate of build material 102, and the like.

In some such implementations, the nozzle 110 is further configured to transmit a signal to the control system 118 indicative of any sensed condition or state such as a conductivity of the build material 102, a type of the build material 102, a diameter of an outlet of the nozzle 110, a force exerted by the drive system 104 to extrude build material 102, a temperature of the heating system 106, or any other useful information. The control system 118 may receive any such signal and control an aspect of the build process in response.

In one aspect, the one or more sensors 170 may include a sensor system configured to volumetrically monitor a temperature of a build material 102, that is, to capture temperature at specific locations within a volume of the build material 102 before extrusion, during extrusion, after extrusion, or some combination of these. This may include surface measurements where available, based on any contact or non-contact temperature measurement technique. This may also or instead include an estimation of the temperature within an interior of the build material 102 at different points along the feed path and within the completed object. Using this accumulated information, a thermal history may be created that includes the temperature over time for each voxel of build material within the completed object 112, all of which may be stored in the digital twin 140 described below and used for in-process control of thermal parameters or post-process review and analysis of the object 112.

The additive manufacturing system 100 may include, or be connected in a communicating relationship with, a network interface 162. The network interface 162 may include any combination of hardware and software suitable for coupling the control system 118 and other components of the additive manufacturing system 100 in a communicating relationship to a remote computer (e.g., the computing device 164) through a data network 160. By way of example and not limitation, this may include electronics for a wired or wireless Ethernet connection operating according to the IEEE 802.11 standard (or any variation thereof), or any other short or long range wireless networking components or the like. This may include hardware for short range data communications such as Bluetooth or an infrared transceiver, which may be used to couple to a local area network or the like that is in turn coupled to a wide area data network such as the Internet. This may also or instead include hardware/software for a WiMAX connection or a cellular network connection (using, e.g., CDMA, GSM, LTE, or any other suitable protocol or combination of protocols). Consistently, the control system 118 may be configured to control participation by the additive manufacturing system 100 in any network 160 to which the network interface 162 is connected, such as by autonomously connecting to the network 160 to retrieve printable content, or responding to a remote request for status or availability of the printer 101.

Other useful features may be integrated into the printer 101 described above. For example, the printer 101 may include a solvent source and applicator, and the solvent (or other material) may be applied to a specific (e.g., controlled by the printer 1010) surface of the object 112 during fabrication, such as to modify surface properties. The added material may, for example, intentionally oxidize or otherwise modify a surface of the object 112 at a particular location or over a particular area in order to provide a desired electrical, thermal, optical, mechanical or aesthetic property. This capability may be used to provide aesthetic features such as text or graphics, or to provide functional features such as a window for admitting RF signals. This may also be used to apply a release layer for breakaway support.

A component handling device can be included for retrieving the printed object 112 from the build chamber 116 upon completion of the printing process, and/or for inserting heavy media. The component handling device can include a mechanism such as a scissor table to elevate the printed object 112. The lifting force of the component handling device can be generated via a pneumatic or hydraulic lever system, or any other suitable mechanical system.

In some implementations, the computing device 164 or the control system 118 may identify or create a support structure 113 that supports a portion of the object 112 during fabrication. In general, the support structure 113 is a sacrificial structure that is removed after fabrication has been completed. In some such implementations, the computing device 164 may identify a technique for manufacturing the support structure 113 based on factors such as the object 112 being manufactured, the materials being used to manufacture the object 112, and user input. The support structure 113 may be fabricated from a high-temperature polymer or other material that will form a weak bond to the build material 102. In another aspect, an interface between the support structure 113 and the object 112 may be manipulated to weaken the interlayer bond to facilitate the fabrication of breakaway support.

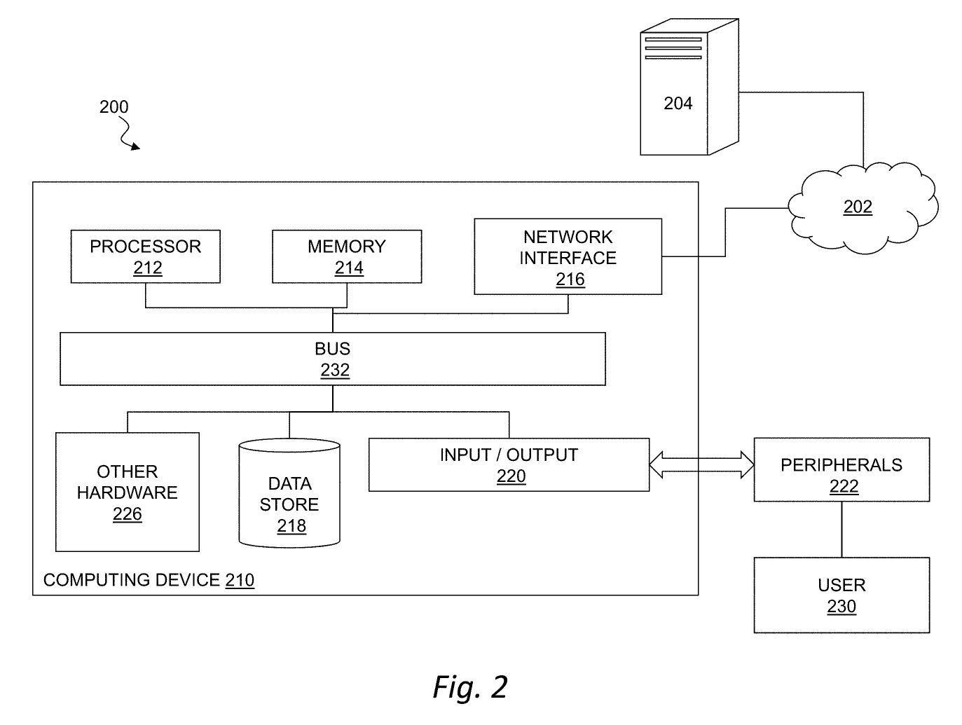

FIG. 2 is a block diagram of a computer system, which may be used for any of the computing devices, control systems or other processing circuitry described herein. The computer system 200 may include a computing device 210, which may also be connected to an external device 204 through a network 202. The computing device 210 may include any of the controllers described herein (or vice-versa), or otherwise be in communication with any of the controllers or other devices described herein. For example, the computing device 210 may include a desktop computer workstation. The computing device 210 may also or instead be any device that has a processor or similar processing circuitry and communicates over a network 202, including without limitation a laptop computer, a desktop computer, a personal digital assistant, a tablet, a mobile phone, a television, a set top box, a wearable computer, and so forth. The computing device 210 may also or instead include a server, or it may be disposed on a server.

The computing device 210 may be used for any of the devices and systems described herein, or for performing the steps of any method described herein. For example, the computing device 210 may include a controller configured by computer executable code to control operation of a printer in the fabrication of an object from a computerized model. In certain aspects, the computing device 210 may be implemented using hardware (e.g., in a desktop computer), software (e.g., in a virtual machine or the like), or a combination of software and hardware. The computing device 210 may be a standalone device, a device integrated into another entity or device, a platform distributed across multiple entities, or a virtualized device executing in a virtualization environment. By way of example, the computing device 210 may be integrated into a three-dimensional printer or a controller for a three-dimensional printer, or the computing device 210 may operate independently from the three-dimensional printer to deliver printable content and remotely control or orchestrate printing operations in various manners.

The network 202 may include any data network(s) or internetwork(s) suitable for communicating data and control information among participants in the computer system 200. This may include public networks such as the Internet, private networks, and telecommunications networks such as the Public Switched Telephone Network or cellular networks using third generation cellular technology (e.g., 3G or IMT-2000), fourth generation cellular technology (e.g., 4G, LTE. MT-Advanced, E-UTRA, etc.) or WiMAX-Advanced (IEEE 102.16m)) and/or other technologies, as well as any of a variety of corporate area, metropolitan area, campus or other local area networks or enterprise networks, along with any switches, routers, hubs, gateways, and the like that might be used to carry data among participants in the computer system 200. The network 202 may also include a combination of data networks, and need not be limited to a single public or private network.

The external device 204 may be any computer or other remote resource that connects to the computing device 210 through the network 202. This may include a platform for print management resources, a gateway or other network devices, remote servers or the like containing content requested by the computing device 210, a network storage device or resource, a device that hosts printing content, or any other resource or device that might connect to the computing device 210 through the network 202.

The computing device 210 may include a processor 212, a memory 214, a network interface 216, a data store 218, and one or more input/output devices 220. The computing device 210 may further include or be in communication with peripherals 222 and other external input/output devices 224.

The processor 212 may be any processor or other processing circuitry described herein, and may generally be configured to execute instructions or otherwise process data within the computing device 210. The processor 212 may include a single-threaded processor, a multi-threaded processor, or any other processor or combination of processors. The processor 212 may be capable of processing instructions stored in the memory 214 or on the data store 218.

The memory 214 may store information within the computing device 210 or computer system 200. The memory 214 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 214 may store program instructions, print instructions, digital models, program data, executables, and other software and data useful for controlling operation of the computing device 200 and configuring the computing device 200 to perform functions for a user. The memory 214 may include a number of different stages and types for different aspects of operation of the computing device 210. For example, a processor may include on-board memory and/or cache for faster access to certain data or instructions, and a separate, main memory or the like may be included to expand memory capacity as desired. While a single memory 214 is depicted, it will be understood that any number of memories may be usefully incorporated into the computing device 210.

The network interface 216 may include any hardware and/or software for connecting the computing device 210 in a communicating relationship with other resources through the network 202. This may include remote resources accessible through the Internet, as well as local resources available using short range communications protocols using, e.g., physical connections (e.g., Ethernet, USB, serial connections, etc.), radio frequency communications (e.g., Wi-Fi), optical communications, (e.g., fiber optics, infrared, or the like), ultrasonic communications, or any combination of these or other media that might be used to carry data between the computing device 210 and other devices. The network interface 216 may, for example, include a router, a modem, a network card, an infrared transceiver, a radio frequency (RF) transceiver, a near field communications interface, a radio-frequency identification (RFID) tag reader, or any other data reading or writing resource or the like.

More generally, the network interface 216 may include any combination of hardware and software suitable for coupling the components of the computing device 210 to other computing or communications resources. By way of example and not limitation, this may include electronics for a wired or wireless Ethernet connection operating according to the IEEE 102.11 standard (or any variation thereof), or any other short or long range wireless networking components or the like. This may include hardware for short range data communications such as Bluetooth or an infrared transceiver, which may be used to couple to other local devices, or to connect to a local area network or the like that is in turn coupled to a data network 202 such as the Internet. This may also or instead include hardware/software for a WiMAX connection or a cellular network connection (using, e.g., CDMA, GSM, LTE, or any other suitable protocol or combination of protocols). The network interface 216 may be included as part of the input/output devices 220 or vice-versa.

The data store 218 may be any internal memory store providing a computer-readable medium such as a disk drive, an optical drive, a magnetic drive, a flash drive, or other device capable of providing mass storage for the computing device 210. The data store 218 may store computer readable instructions, data structures, digital models, print instructions, program modules, and other data for the computing device 210 or computer system 200 in a non-volatile form for subsequent retrieval and use. For example, the data store 218 may store without limitation one or more of the operating system, application programs, program data, databases, files, and other program modules or other software objects and the like.

The input/output interface 220 may support input from and output to other devices that might couple to the computing device 210. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also or instead include an infrared interface, RF interface, magnetic card reader, or other input/output system for coupling in a communicating relationship with other local devices. It will be understood that, while the network interface 216 for network communications is described separately from the input/output interface 220 for local device communications, these two interfaces may be the same, or may share functionality, such as where a USB port is used to attach to a Wi-Fi accessory, or where an Ethernet connection is used to couple to a local network attached storage.

A peripheral 222 may include any device used to provide information to or receive information from the computing device 200. This may include human input/output (I/O) devices such as a keyboard, a mouse, a mouse pad, a track ball, a joystick, a microphone, a foot pedal, a camera, a touch screen, a scanner, or other device that might be employed by the user 230 to provide input to the computing device 210. This may also or instead include a display, a speaker, a printer, a projector, a headset or any other audiovisual device for presenting information to a user. The peripheral 222 may also or instead include a digital signal processing device, an actuator, or other device to support control or communication to other devices or components. Other I/O devices suitable for use as a peripheral 222 include haptic devices, three-dimensional rendering systems, augmented-reality displays, magnetic card readers, user interfaces, and so forth. In one aspect, the peripheral 222 may serve as the network interface 216, such as with a USB device configured to provide communications via short range (e.g., Bluetooth, Wi-Fi, Infrared, RF, or the like) or long range (e.g., cellular data or WiMAX) communications protocols. In another aspect, the peripheral 222 may provide a device to augment operation of the computing device 210, such as a global positioning system (GPS) device, a security dongle, or the like. In another aspect, the peripheral may be a storage device such as a flash card, USB drive, or other solid state device, or an optical drive, a magnetic drive, a disk drive, or other device or combination of devices suitable for bulk storage. More generally, any device or combination of devices suitable for use with the computing device 200 may be used as a peripheral 222 as contemplated herein.

Other hardware 226 may be incorporated into the computing device 200 such as a co-processor, a digital signal processing system, a math co-processor, a graphics engine, a video driver, and so forth. The other hardware 226 may also or instead include expanded input/output ports, extra memory, additional drives (e.g., a DVD drive or other accessory), and so forth.

A bus 232 or combination of busses may serve as an electromechanical platform for interconnecting components of the computing device 200 such as the processor 212, memory 214, network interface 216, other hardware 226, data store 218, and input/output interface. As shown in the figure, each of the components of the computing device 210 may be interconnected using a system bus 232 or other communication mechanism for communicating information.

Methods and systems described herein can be realized using the processor 212 of the computer system 200 to execute one or more sequences of instructions contained in the memory 214 to perform predetermined tasks. In embodiments, the computing device 200 may be deployed as a number of parallel processors synchronized to execute code together for improved performance, or the computing device 200 may be realized in a virtualized environment where software on a hypervisor or other virtualization management facility emulates components of the computing device 200 as appropriate to reproduce some or all of the functions of a hardware instantiation of the computing device 200.

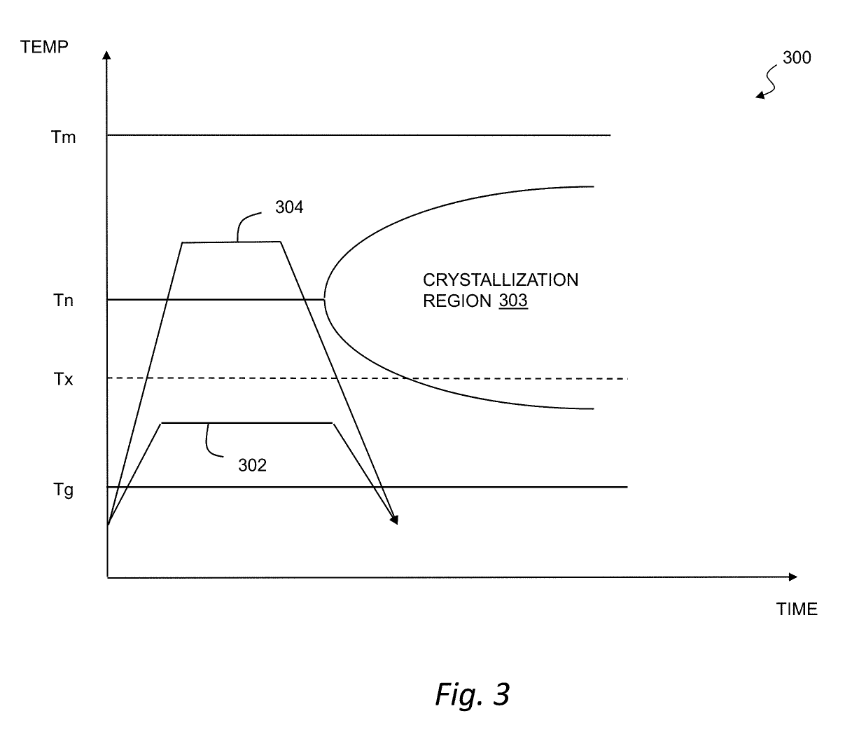

FIG. 3 shows the time-temperature-transformation (TTT) cooling curve 300 of a bulk metallic glass that may be used as a build material with a metal additive manufacturing process as contemplated herein. Bulk metallic glasses may be usefully employed as a build material for the fabrication systems contemplated herein. These bulk metallic glasses do not exhibit a liquid/solid crystallization transformation upon cooling, as with conventional metals. Instead, the non-crystalline form of the metal found at high temperatures (near a “melting temperature” Tₘ) becomes more viscous as the temperature is reduced (near to the glass transition temperature T_{g}), eventually taking on the physical properties of a conventional solid while maintaining an amorphous internal structure. Within this intermediate temperature range, the bulk metallic glass can exhibit rheological properties suitable for use in a fused filament fabrication process.

Even though there is no direct liquid/crystallization transformation for a bulk metallic glass, a melting temperature, Tₘ, may be defined as the thermodynamic liquidus temperature of the corresponding crystalline phase. Under this regime, the viscosity of bulk-solidifying amorphous alloys at the melting temperature could lie in the range of about 0.1 poise to about 10,000 poise, and even sometimes under 0.01 poise. In order to form a BMG, the cooling rate of the molten metal must be sufficiently high to avoid the elliptically-shaped region bounding the crystallized region 303 in the TTT diagram of FIG. 3. In FIG. 3, Tₙ (also referred to as Tₙₒₛₑ) is the critical crystallization temperature, Tₓ, where the rate of crystallization is the greatest and crystallization occurs in the shortest time scale.

The supercooled liquid region, the temperature region between T_{g} and Tₓ is a manifestation of a stability against crystallization that permits the bulk solidification of an amorphous alloy. In this temperature region, the bulk metallic glass alloy can exist as a highly viscous liquid. The viscosity in the supercooled liquid region can vary between 10¹² Pa s at the glass transition temperature down to 10⁵ Pa s at the crystallization temperature, the high-temperature limit of the supercooled liquid region. Liquids with such viscosities can undergo substantial plastic strain under an applied pressure, and this large plastic formability in the supercooled liquid region permits use in a fused filament fabrication system as contemplated herein. As a significant advantage, bulk metallic glasses that remain in the supercooled liquid region are not generally subject to oxidation or other rapid environmental degradation, thus typically requiring less control of the environment within a build chamber during fabrication than some other metal systems that might be used for fused filament fabrication.

The supercooled alloy may in general be formed or worked into a desired shape for use as a wire, rod, billet, or the like. In general, forming may take place simultaneously with fast cooling to avoid any subsequent thermoforming with a trajectory approaching the TTT curve. In an additive manufacturing extrusion process, the amorphous BMG can be reheated into the supercooled liquid region without hitting the TTT curve where the available processing window could be much larger than die casting, resulting in better controllability of the process. Also, as shown by example trajectories 302 and 304, the extrusion can be carried out with the highest temperature during extrusion being above Tₙₒₛₑ or below Tₙₒₛₑ, up to about Tₘ. If one heats up a piece of amorphous alloy but manages to avoid hitting the TTT curve, then the material can be manipulated in this relatively plastic state without reaching the crystallization temperature, Tₓ. A variety of suitable metallic and nonmetallic elements useful for glass-forming alloys are described by way of non-limiting examples, in commonly-owned U.S. Prov. App. No. 62/268,458, filed on Dec. 16, 2015, the entire content of which is incorporated by reference herein.

An amorphous or non-crystalline solid is a solid that lacks lattice the periodicity characteristic of a crystal. As used herein, the term amorphous solid includes a glass, which is an amorphous solid that softens and transforms into a liquid-like state upon heating through the glass transition. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The alloys contemplated herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous or fully amorphous. In one embodiment, the alloy composition is at least substantially not amorphous, such as being substantially crystalline or entirely crystalline.

In one embodiment, the presence of a crystal or a plurality of crystals in an otherwise amorphous alloy can be construed as a “crystalline phase” therein. The degree of crystallinity (or simply “crystallinity) of an alloy can refer to the amount of the crystalline phase present in the alloy or a fraction of crystals present in the alloy. The fraction can refer to volume fraction or weight fraction, depending on the context. Similarly, amorphicity expresses how amorphous or unstructured an amorphous alloy is. Amorphicity can be measured relative to a degree of crystallinity. Thus, an alloy having a low degree of crystallinity will have a high degree of amorphicity and vice versa. By way of quantitative example, an alloy having 60 vol % crystalline phase will have a 40 vol % amorphous phase.

An amorphous alloy is an alloy having an amorphous content of more than 50% by volume, preferably more than 90% by volume of amorphous content, more preferably more than 95% by volume of amorphous content, and most preferably more than 99% to almost 100% by volume of amorphous content. Note that, as described above, an alloy high in amorphicity is equivalently low in degree of crystallinity. As used herein, the term amorphous metal refers to an amorphous metal material with a disordered atomic-scale structure. In contrast to most metals, which are crystalline and therefore have a highly-ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” As used herein, the term bulk metallic glass (“BMG”) refers to an alloy with a wholly or partially amorphous microstructure.

The terms “bulk metallic glass” (“BMG”) and bulk amorphous alloy (“BAA”), are used interchangeably herein. They refer to amorphous alloys having the smallest physical dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm. Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous alloys have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which omits dislocation defects or the like that might limit the strength of crystalline alloys. In some embodiments, metallic glasses at room temperature are not ductile and tend to fail suddenly when loaded in tension, which limits the material applicability in reliability-critical applications, as the impending failure is not evident. Therefore, to overcome this challenge, metal matrix composite materials having a metallic glass matrix containing dendritic particles or fibers of a ductile crystalline metal can be used for fused filament fabrication. Alternatively, a BMG low in element(s) that tend to cause embrittlement (e.g., Ni) can be used. For example, a Ni-free BMG can be used for improved ductility.

As described above, the degree of amorphicity (and conversely the degree of crystallinity) can be measured by fraction of crystals present in the alloy, e.g., in units of volume, weight or the like. A partially amorphous composition can refer to a composition with an amorphous phase of at least about 5 vol %, 10 vol %, 20 vol %, 40 vol %, 60 vol %, 80 vol %, 90 vol %, or any other non-zero amount. Accordingly, a composition that is at least substantially amorphous can refer to one with an amorphous phase of at least about 90 vol %, 95 vol %, 98 vol %, 99 vol %, 99.9 vol %, or any other similar range or amount. In one embodiment, a substantially amorphous composition can have some incidental, insignificant amount of crystalline phase present therein.

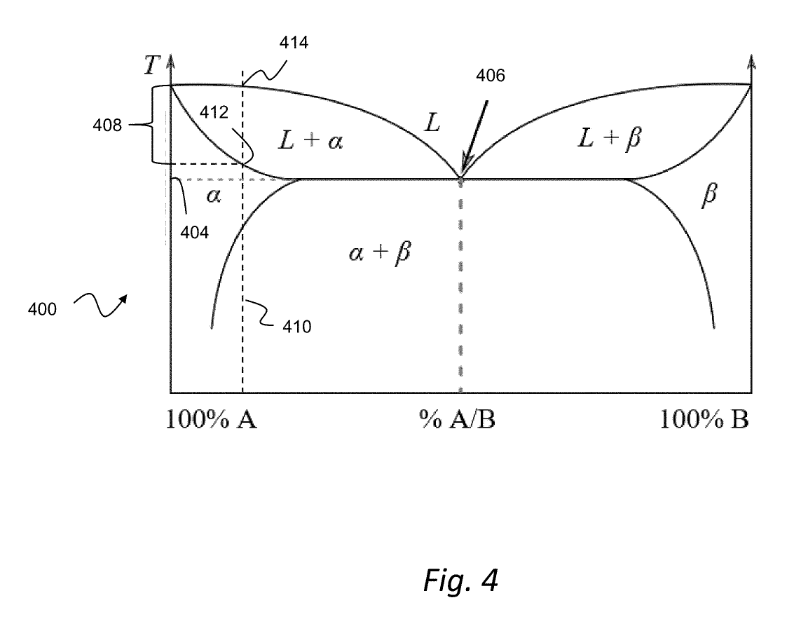

FIG. 4 shows a phase diagram 400 for an off-eutectic composition of a eutectic system suitable for use as a build material in the methods and systems described herein. In general, the build material may include an off-eutectic or non-eutectic alloy with a working temperature range in which the mixture contains solid and liquid components in an equilibrium volume proportion dependent on temperature. This multi-phase condition usefully increases viscosity of the material above the pure liquid viscosity while in the working temperature range to render the material in a flowable state exhibiting rheological properties suitable for fused filament fabrication or similar extrusion-based additive manufacturing techniques. An inert high-temperature second phase may also be introduced into an off-eutectic system to further control viscosity. In another aspect, an inert second phase may be used with a substantially pure eutectic alloy. This combination provides a dual advantage of the relatively low melting temperature that is characteristic of eutectic alloys, along with the desirable flow characteristics that can be imparted by an added inert second phase.

In general, where multiple phases exist such that a eutectic forms between the phases, the melting point for the aggregate composition will be the liquidus temperature. When the off-eutectic alloy solidifies, its components solidify at different temperatures, resulting in a semi-solid suspension of solid and liquid components prior to full solidification. The working temperature for an off-eutectic composition is generally a range of temperatures between a lowest and highest melting temperature. In a (volume percentage) mixture around the eutectic point 402, the lowest melting temperature (at which this mixture remains partially molten) is the eutectic temperature 404 for a pure eutectic composition within the system. The highest melting temperature will generally be a function of the volume percentage of the components A and B. In regions far from the eutectic composition such that the eutectic line terminates, i.e., at the far left or the far right of the phase diagram 400, the lowest melting temperature may be somewhat above the eutectic temperature, e.g., at the solidus temperature of the alloy. For example, for an off-eutectic composition with a very high fraction of material A (as indicated by a line 410), the composition may have a solidus temperature 412 somewhat above the eutectic temperature, and a liquidus temperature 414 at the highest liquidus temperature for the composition. For either type of composition, the off-eutectic system may have a working temperature range including a range of temperatures above a lowest melting temperature (e.g., where the entire system becomes solid) and below a highest melting temperature (e.g., where the entire system becomes liquid) where the composition, or a corresponding metallic build material includes solid and liquid phases in a combination providing a variable, temperature-dependent viscosity and rheological properties suitable for extrusion. This working temperature range 408 will vary by composition and alloying elements, but may be adapted for a wide range of metal alloys for use in a fused filament fabrication process or the like as contemplated herein.

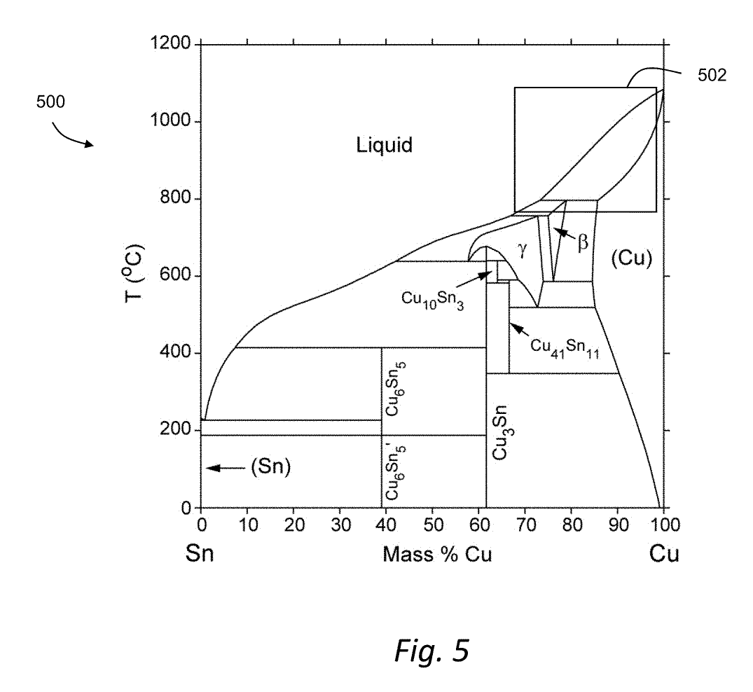

FIG. 5 shows a phase diagram for a peritectic system. As used herein, a peritectic system refers to a chemical system wherein a solid phase and a liquid phase may react upon cooling to form a third, solid phase. In particular, FIG. 5 shows a phase diagram 500 for a relatively common peritectic system of 90/10 bronze. This system can provide a working temperature range 502 in which the constituent elements form a multi-phase mixture between solid and liquid parts. In this range of temperatures, an equilibrium volume fraction of solid and liquid can be controlled by varying temperature. The rheology of the extrudate can be tuned by tuning the volume fraction (and therefore the temperature) of the composition, and the resulting material can provide a substantially plastic temperature behavior suitable for extrusion. While the highly non-uniform solidification behavior may present design and handling challenges, this technique may be usefully applied for fabrication with bronze and similar alloys and materials.

In certain aspects, a chemical system that exhibits a two-phase equilibrium between a solid and a liquid without exhibiting either a eutectic or a peritectic phase behavior may exhibit a useful rheology for extrusion at temperature in a two-phase, semisolid region. In general, for a given composition, a useful flow behavior may exist at a range of temperatures between the solidus and the liquidus of the particular alloy.

Still more generally, any partially or wholly metallic mixture that exhibits suitable temperature response may be adapted for use in an extrusion-type additive manufacturing process as contemplated herein. For example, some chemical systems exhibit a two-phase equilibrium between a solid and a liquid without exhibiting either a eutectic or a peritectic phase behavior. Such systems may provide a working temperature range between a solidus and liquidus with a two-phase, semisolid region having a rheology suitable for use in fused filament fabrication process as contemplated herein.

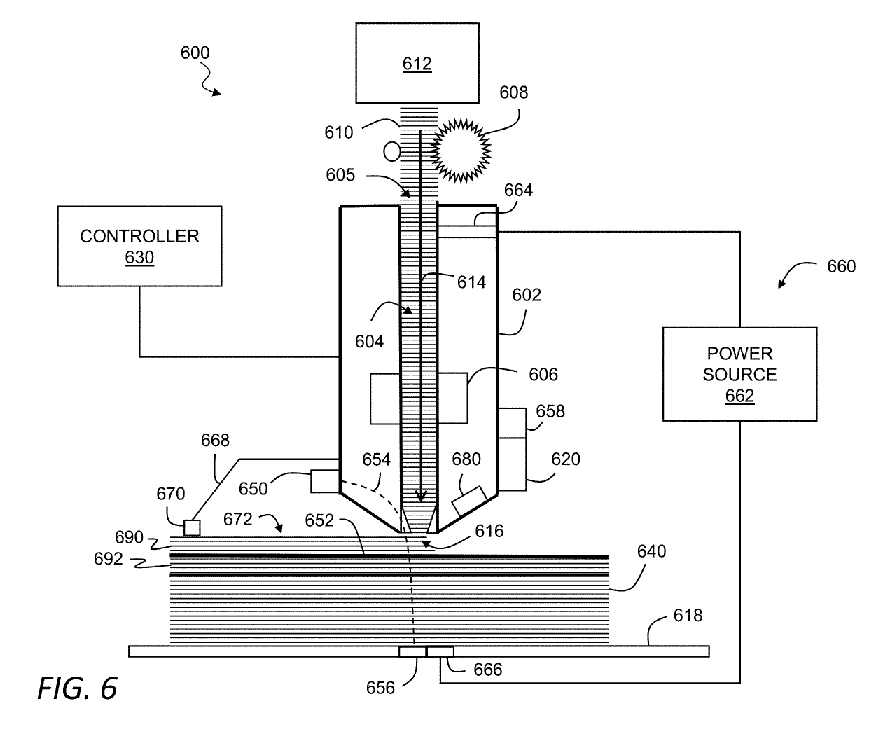

FIG. 6 shows an extruder 600 for a three-dimensional printer. In general, the extruder 600 may include a nozzle 602, a reservoir 604, a heating system 606, and a drive system 608 such as any of the systems described herein, or any other devices or combination of devices suitable for a printer that fabricates an object from a computerized model using a fused filament fabrication process and a metallic build material as contemplated herein. In general, the extruder 600 may receive a build material 610 from a source 612, such as any of the build materials and sources described herein, and advance the build material 610 along a feed path (indicated generally by an arrow 614) toward an opening 616 of the nozzle 602 for deposition on a build plate 618 or other suitable surface. The term build material is used herein interchangeably to refer to metallic build material, species and combinations of metallic build materials, or any other build materials (such as thermoplastics). As such, references to “build material 610” should be understood to include a metallic build material 610, a bulk metallic glass 610, an off-eutectic composition 610, or any of the other build material or combination of build materials described herein, unless a more specific meaning is provided or otherwise clear from the context.

The nozzle 602 may be any nozzle suitable for the temperatures and mechanical forces required for the build material 610. For extrusion of metallic build materials, portions of the nozzle 602 (and the reservoir 604) may be formed of hard, high-temperature materials such as sapphire or quartz, which provide a substantial margin of safety for system components, and may usefully provide electrical isolation where needed for inductive or resistive heating systems.

The reservoir 604 may be any chamber or the like suitable for heating the build material 610, and may include an entrance 605 to receive a build material 610 such as any of the metallic build materials described herein, from the source 612. The metallic build material may have a working temperature range between a solid and a liquid state where the metallic build material exhibits rheological properties suitable for extrusion. While useful build materials may exhibit a wide range of bulk mechanical properties, the plasticity of the heated build material 610 should generally be such that the material is workable and flowable by the drive system 608, nozzle 602, and other components on one hand, while being sufficiently viscous or pasty to avoid runaway flow through the extruder 600 during deposition on the other.

The heating system 606 may employ any of the heating devices or techniques described herein. In general, the heating system 606 may be operable to heat the build material 610, e.g., a metallic build material, within the reservoir 604 to a temperature within the working temperature range for the build material 610. It will be understood that the heating system 606 may also or instead be configured to provide additional thermal control, such as by locally heating the build material 610 where it exits the nozzle 602 or fuses with a second layer 692 of previously deposited material, or by heating a build chamber or other build environment where the nozzle 602 is fabricating an object.

The nozzle 602 may include an opening 616 that provides an exit path for the build material 610 to exit the reservoir 604 along the feed path 614 where, for example, the build material 610 may be deposited on the build plate 618.

The drive system 608 may be any drive system operable to mechanically engage the build material 610 in solid form and advance the build material 610 from the source 612 into the reservoir 604 with sufficient force to extrude the build material 610, while at a temperature within the working temperature range, through the opening 616 in the nozzle 602. In general, the drive system 608 may engage the build material 610 while at a temperature below the working temperature range, e.g., in solid form, or at a temperature below a top of the working temperature range where the build material 610 is more pliable but still sufficiently rigid to support extrusion loads and translate a driving force from the drive system 608 through the build material 610 to extrude the heated build material in the reservoir 604.

Unlike thermoplastics conventionally used in fused filament fabrication, metallic build materials are highly thermally conductive. As a result, high reservoir temperatures can contribute to elevated temperatures in the drive system 608. Thus, in one aspect, a bottom of the working temperature range for the reservoir 604 and nozzle 602 may be any temperature within the temperature ranges described above that is also above a temperature of the build material 610 where it engages the drive system 608, thus providing a first temperature range for driving the build material 610 and a second temperature range greater than the first temperature range for extruding the build material 610. Or stated alternatively and consistent with the previously discussed working temperature ranges, the build material 610 may typically be maintained within the working temperature range while extruding and below the working temperature range while engaged with the drive system 608, however, in some embodiments the build material 610 may be maintained within the working temperature when engaged with the drive system 608 and when subsequently extruded from by the nozzle 602. All such temperature profiles consistent with extrusion of metallic build materials as contemplated herein may be suitably employed. While illustrated as a gear, it will be understood that the drive system 608 may include any of the drive chain components described herein, and the build material 610 may be in any suitable, corresponding form factor.

An ultrasonic vibrator 620 may be incorporated into the extruder 600 to improve the printing process. The ultrasound vibrator 620 may be any suitable ultrasound transducer such as a piezoelectric vibrator, a capacitive transducer, or a micromachined ultrasound transducer. The ultrasound vibrator 620 may be positioned in a number of locations on the extruder 600 according to an intended use. For example, the ultrasound vibrator 620 may be coupled to the nozzle 602 and positioned to convey ultrasonic energy to a build material 610 such as a metallic build material where the metallic build material extrudes through the opening 616 in the nozzle 602 during fabrication.

The ultrasonic vibrator 620 may improve fabrication with metallic build materials in a number of ways. For example, the ultrasonic vibrator 620 may be used to disrupt a passivation layer (e.g., due to oxidation) on deposited material in order to improve layer-to-layer bonding in a fused filament fabrication process. An ultrasound vibrator 620 may provide other advantages, such as preventing or mitigating adhesion of a build material 610 such as a metallic build material to the nozzle 602 or an interior wall of the reservoir 604. In another aspect, the ultrasound vibrator 620 may be used to provide additional heating to the build material 610, or to induce shearing displacement within the reservoir 604, e.g., to mitigate crystallization of a bulk metallic glass.

A printer (not shown) incorporating the extruder may also include a controller 630 to control operation of the ultrasonic vibrator 620 and other system components. For example, the controller 630 may be coupled in a communicating relationship with the ultrasonic vibrator 620 (or a control or power system for same) and configured to operate the ultrasonic vibrator 620 with sufficient energy to ultrasonically bond an extrudate of a metallic build material exiting the extruder 602 to an object 640 formed of one or more previously deposited layers of the metallic build material on the build plate 618. The controller 630 may also or instead operate the ultrasonic vibrator 620 with sufficient energy to interrupt a passivation layer on a receiving surface of a previously deposited layer of the build material 610, such as the second layer 692 depicted in FIG. 6. In another aspect, the controller 630 may operate the ultrasonic vibrator with sufficient energy to augment thermal energy provided by the heating system to maintain the metallic build material at the temperature within the working temperature range within the reservoir. The controller 630 may also or instead operate the ultrasonic vibrator 620 with sufficient energy to reduce adhesion of the build material 610 to the nozzle 602 (e.g. around the opening 616) and an interior of the reservoir 604.

Where the build material 610 includes a bulk metallic glass, the ultrasonic vibrator 620 may also or instead be used to create a brittle interface to a support structure. For example, the controller 630 may be configured to operate the ultrasonic vibrator 620 with sufficient energy to liquefy the bulk metallic glass at a layer (such as the interface layer 652) between the object 640 fabricated with the bulk metallic glass from the nozzle 602 and a support structure for the object 640 fabricated with the bulk metallic glass. The liquefied bulk metallic glass will typically re-solidify with a crystalline macrostructure that is substantially more brittle than the amorphous, supercooled material. This technique advantageously facilitates the fabrication of breakaway support structures in arbitrary locations using a single build material.

The extruder 600 may also include a mechanical decoupler 658 interposed between the ultrasonic vibrator 620 and one or more other components of the printer to decouple ultrasound energy from the ultrasonic vibrator. The mechanical decoupler 658 may, for example, include any suitable decoupling element such as an elastic material or any other acoustic decoupler or the like. The mechanical decoupler 658 may isolate other components, particularly components that might be mechanically sensitive, from ultrasound energy generated by the ultrasonic vibrator 620, and/or to direct more of the ultrasonic energy toward an intended target such as an interior wall of the reservoir 604 or the opening 616 of the nozzle 602.

The extruder 600 or the accompanying printer may also include a sensor 650 that provides feedback to the controller 630 for controlling a fabrication process. For example, the sensor 650 may provide a signal for use in variably or otherwise selectively controlling activation of the ultrasonic vibrator 620.

In one aspect, the sensor 650 may include a sensor for monitoring a suitability of a receiving surface of a previously deposited layer of the build material 610. For example, where the build material 610 is a metallic build material, the sensor 650 may measure electrical resistance through an interface layer 652 between build material 610 exiting the nozzle 602 and a previously deposited layer of the build material 610 in the object 640, where the resistance is measured along a current path 654 between the sensor 650 and a second sensor 656 in the build plate 618 or some other suitable circuit-forming location. Where the bond across the interface layer 652 is good, the resistance along the current path 654 will tend to be low, while a poor bond across the interface layer 652 will result in greater resistance along the current path 654. Thus, the controller 630 may be configured to dynamically control operation of the ultrasonic vibrator 620 in response to a signal from the sensor 650 such as a signal indicative of electrical resistance across the interface layer 652, and to increase ultrasonic energy from the ultrasonic vibrator 620 as needed to improve fusion of the layers of build material 610 across the interface layer 652. Thus, in one aspect, the sensor 650 may measure a quality of bond between adjacent layers of a metallic build material 610 and the controller 630 may be configured to increase an application of ultrasound energy from the ultrasonic vibrator 620 in response to a signal from the sensor 650 indicating that the quality of the bond is poor.

In another aspect, the sensor 650 may be used to detect clogging of the build material 610, or crystallization of a bulk metallic glass build material, and to control the ultrasonic vibrator 620 to mitigating the detected condition. For example, the sensor 650 may include a force sensor configured to measure a force applied to the build material 610 by the drive system 608, and the controller 630 may be configured to increase ultrasonic energy applied by the ultrasonic vibrator 620 to the reservoir 604 in response to a signal from the sensor 650 indicative of an increase in the force applied by the drive system 604. The force may be measured with a mechanical force sensor, or by measuring, e.g., a power load on the drive system 608.

A force sensor that measures the force applied to the build material 610 may be used in other ways. For example, the force sensor may be used to estimate a viscosity of the build material 610, which may in turn be used to estimate a temperature of the build material 610 where the temperature-viscosity relationship for the build material 610 is known. At the same time, because heat transfer from a heating system to the build material 610 is time dependent, a speed of the drive system 608 may be dynamically adjusted to control heating of material in the reservoir by controlling how long the build material 610 is adjacent to a heat source. Thus, a control loop may usefully be established in which the load on the drive system 608, measured, e.g., as linear or axial force on the build material 610 relative to the drive system 608 or the nozzle 602, can be used as a control signal to dynamically vary the drive or extrusion speed. In one aspect, a processor (e.g., the controller 630) may be configured to increase the speed of the drive system 608 to decrease a heat transfer when the force decreases, and to decrease the speed of the drive system 608 to increase the heat transfer when the force increases. The processor may more generally be configured to maintain a predetermined target value for the force indicative of a temperature within the working temperature range for the build material. Force feedback may provide other useful control signals to an extrusion process. For example, where the build material 610 includes a bulk metallic glass, a target temperature for the feedback system may vary according to a time-temperature transformation curve for the bulk metallic glass in order to avoid an onset of substantial crystallization.

In another aspect, an error condition may be detected when the force resisting advancement of a metallic build material varies in an unexpected manner, e.g., when decreasing the extrusion rate fails to decrease the force. Under these circumstances, a clog or other error may be inferred, and a remedial action may be initiated by the processor such as cleaning the nozzle or pausing a fabrication process to permit user inspection or intervention. It will be understood that a variety of force sensors may be employed to measure force for these purposes including, e.g., strain gauges or the like along the nozzle 602 or along a mechanical structure coupling the nozzle 602 to the drive system 608, or any other force measurement sensor or system physically positioned to measure force applied by the drive system 608 to the build material 610. Other sensors such as a rotary force sensor for a drive motor or a sensor that detects an electrical load on the drive motor may also or instead be employed to obtain a suitable control input.

Where the build material 610 is a metallic build material, the extruder 600 may also or instead include a resistance heating system 660. The resistance heating system 660 may include an electrical power source 662, a first lead 664 coupled in electrical communication with the metallic build material 610 in a first layer 690 of the number of layers of the build material 610 proximal to the nozzle 602 and a second lead 666 coupled in electrical communication with a second layer 692 of the number of layers proximal to the build plate 656, thereby forming an electrical circuit through the build material 610 for delivery of electrical power from the electrical power source 662 through an interface (e.g., at the interface layer 652) between the first layer 690 and the second layer 692 to resistively heat the metallic build material across the interface.

It will be understood that a wide range of physical configurations may serve to create an electrical circuit suitable for delivering current through the interface layer 652. For example, the second lead 666 may be coupled to the build plate 618, and coupled in electrical communication with the second layer 692 via a conductive path through the body of the object 640, or the second lead 666 may be attached to a surface of the object 640 below the interface layer 652, or implemented as a moving probe or the like that is positioned in contact the with surface of the object at any suitable position to complete a circuit through the interface layer 652. In another aspect, the first lead 666 may be coupled to a movable probe 668 controllably positioned on a surface of an object 640 fabricated with the metallic build material that has exited the nozzle 602, and may include a brush lead 670 or the like contacting a surface 672 of the build material 610 at a predetermined location adjacent to the exit 616 of the nozzle 602. The first lead 664 may also or instead be positioned in a variety of other locations. For example, the first lead 664 may couple to the build material 610 on an interior surface of the reservoir 604, or the first lead 664 may couple to the build material 610 at the opening 616 of the nozzle 602. However configured, the first lead 664 and the second lead 666 may generally be positioned to create an electrical circuit through the interface layer 652.

With this general configuration, Joule heating may be used to fuse layers of build material 610 in the object 640. In general, Joule heating may be used to soften or melt the print media at the physical interface between a build material and an object that is being manufactured. This may include driving a circuit through the interface layer 652 with variable pulsed joule and/or DC signals to increase temperature and adhere individual layers made of, e.g., a BMG or semisolid printed metal, or any other metal media with suitable thermal and electrical characteristics. A wide range of signals may be used to discharge electrical power across the interface layer 652. For example, a low voltage (e.g. less than twenty-four Volts) and high current (e.g., on the order of hundreds or thousands of Amps) may be applied in low frequency pulses of between about one Hertz and one hundred Hertz. Delivery of power may be controlled, e.g., using pulse width modulation of a DC current, controlled discharge of capacitors, or through any other suitable techniques.

Joule heating may advantageously be used for other purposes. For example, current may be intermittently applied across surfaces inside a nozzle 602 in order to melt or soften metallic debris that has solidified on interior walls, thus cleaning the nozzle 602. Thus, a technique disclosed herein may include periodically applying a Joule heating pulse across interior surfaces of a dispensing nozzle to clean and remove metallic debris. This step may be performed on a predetermined, regular schedule, or this step may be performed in response to a detection of increased mechanical resistance along the feed path 614 for the build material 610 indicative of a potential clog, or in response to any other suitable signal or process variable.

In general, Joule heating may be applied with constant power during a print process, or with a variable power that varies either dynamically, e.g., based on a sensed condition of an inter-layer bond, or programmatically based on, e.g., a volume flow rate, deposition surface area, or some other factor or collection of factors. Other electrical techniques may be used to similar effect. For example, capacitive discharge resistance welding equipment uses large capacitors to store energy for quick release. A capacitive discharge welding source may be used to heat an interface between adjacent layers in pulses while a new layer is being deposited. Joule heating and capacitive discharge welding may be advantageously superposed using the same circuit. In one aspect, where the build material 610 includes a bulk metallic glass, the bulk metallic glass may be fabricated with a glass former selected from the group consisting of boron, silicon, and phosphorous combined with a magnetic metal selected from the group consisting of iron, cobalt and nickel to provide an amorphous alloy with increased electrical resistance to facilitate Joule heating.

The resistance heating system 660 may be dynamically controlled according to sensed conditions during fabrication. For example, a sensor system 680 may be configured to estimate an interface temperature at an interface (e.g., the interface layer 652) between a first region of the metallic build material exiting the nozzle 602 and a second region of the metallic build material within a previously deposited layer of the metallic build material below and adjacent to the first region. This may, for example, include a thermistor, an infrared sensor, or any other sensor or combination of sensors suitable for directly or indirectly measuring or estimating a temperature at the interface layer 652. With an estimated or measured signal indicative of the interface temperature, the controller may be configured to adjust a current supplied by the electrical power source 662 in response to the interface temperature, e.g., so that the interface layer 652 can be maintained at an empirical or analytically derived target temperature for optimum interlayer adhesion.

In one aspect, the sensor 650 may include a voltage sensing circuit or other voltage detector, which may be configured to measure a voltage between a pair of terminals positioned across an interface between the metallic build material exiting the nozzle 602 and the opening 616 of the nozzle 602, which in combination with known Seebeck coefficients for the build material and the nozzle material, may be used to measure a temperature difference between the materials. The sensor 650 may also include a temperature sensor configured to measure an absolute temperature of the nozzle 602 at a suitable location, which may be used in combination with the temperature difference to calculate an estimate of an absolute temperature of the metallic build material where it is exiting the nozzle 602. The voltage may also or instead respond to any change in a state of the build material leading to a change in the corresponding Seebeck coefficient. Thus, for example where the build material includes a bulk metallic glass that can transform from an amorphous to a crystalline state, a processor may be configured to calculate a change in a degree of crystallinity of the bulk metallic glass based on any change in the voltage that is uncorrelated to a change in a temperature difference between the nozzle 602 and the metallic build material that is exiting the nozzle 602. Where an onset of crystallization is detected, the processor may be further configured to reduce a heat applied to the metallic build material in order to inhibit the continuation of crystallization. Alternatively, where crystallization is intended or desired, e.g., to create a breakaway support layer as described herein, the processor may be configured to increase a heat applied to the metallic build material to encourage the onset of crystallization in response to a change in the voltage, or to increase the heat until a predetermined state (as measured via the Seebeck effect) is achieved.

As noted above, a printer may include two or more nozzles and extruders for supplying multiple build and support materials or the like. Thus, the extruder 600 may be a second extruder for extruding a supplemental build material. For example, the extruder 600 may deposit a support material for fabricating support structures, or an interface layer providing a breakaway interface for easily removable support structures. In one embodiment, the second extruder may be configured to deposit a support material for an additive fabrication process, where the support material includes a dissolvable bulk metallic glass. For example, dissolvable bulk metallic glasses formed of alloys containing magnesium, calcium and lithium, have been demonstrated to dissolve under various conditions. Some bulk metallic glasses are dissolvable in an aqueous solution containing hydrogen chloride. Others are dissolvable in an aqueous solution or pure water. By way of a more specific example, magnesium copper yttrium has been demonstrated to dissolve readily in an oxidizing solution. Further, a number of alloys with a magnesium calcium base have been demonstrated to dissolve in simulated physiological fluid, e.g., for biodegradable implants, and may be suitably employed as a dissolvable bulk metallic glass support material as contemplated herein.

More generally, any such alloy that can form a bulk metallic glass and be dissolved in a solvent substantially more quickly than associated build materials—e.g., that dissolves at least ten times faster than a metallic build material in a predetermined solvent, or still more generally, at a rate that prevents substantial degradation of the fabricated object in the presence of the corresponding solvent—may be suitably employed as a dissolvable bulk metallic glass for forming dissolvable support structures or interface layers as contemplated herein. Such materials are preferably also thermally matched as necessary to avoid undesirable thermal affects at interfaces between different materials.

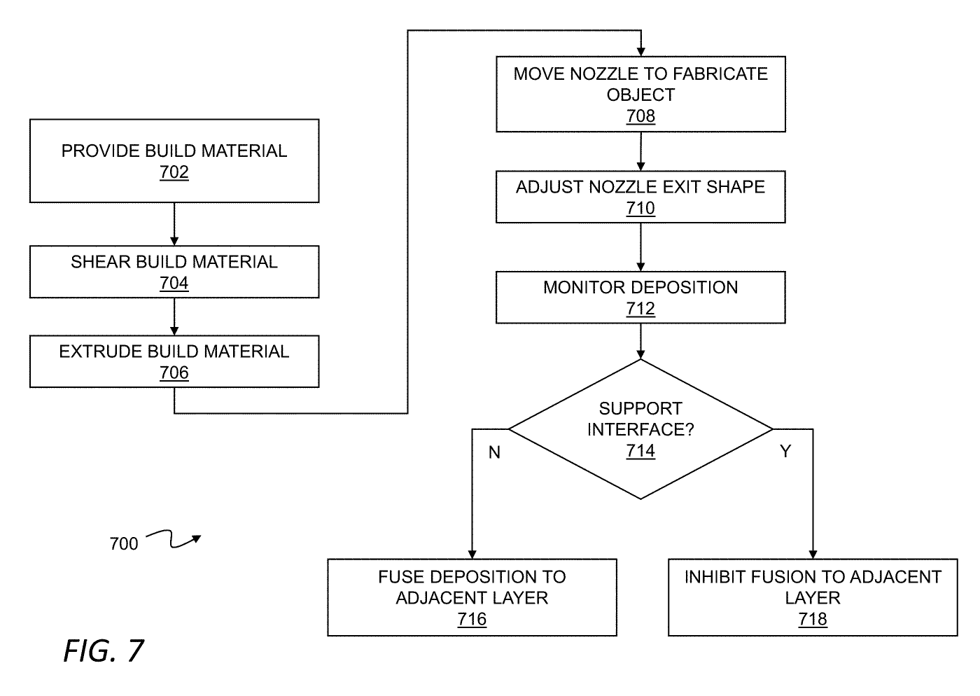

FIG. 7 shows a flow chart of a method for operating a printer in a three-dimensional fabrication of an object.

As shown in step 702, the method 700 may begin with providing a build material such as any of the build materials described herein to an extruder. By way of example, the build material may include a bulk metallic glass, an off-eutectic composition of eutectic systems, a metallic base loaded with a high-temperature inert second phase, a peritectic composition, or a sinterable powder in a wax, polymer, or other binder. While the following description emphasizes the use of metallic build materials with a working temperature range having rheological properties suitable for extrusion, in some aspects the build material may also or instead include a thermoplastic such as acrylonitrile butadiene styrene (ABS), polylactic acid (PLA), polyether ether ketone (PEEK) or any other suitable polymer or the like.

As shown in step 704, the method 700 may optionally include shearing the build material, e.g., where the build material includes a bulk metallic glass or other material susceptible to crystal formation or hardening under processing conditions. As further described herein, bulk metallic glasses are subject to degradation as a result of crystallization during prolonged heating. Eutectic compositions may also yield relatively large agglomerations of solid particles during prolonged dwells within the working temperature range. When these or similarly vulnerable metallic build materials are heated, e.g., in the reservoir of an extruder, a shearing force may be applied by a shearing engine to mitigate or prevent crystallization or other clumping or grouping. In general, shearing may include any technique for applying a shearing force to the material within the reservoir to actively induce a shearing displacement of a flow of the material along a feed path through the reservoir to the nozzle to mitigate crystallization or other disruptive phenomena. Where a mechanical resistance to flow of the bulk metallic glass is measured, the shearing may be controlled dynamically. Thus, in one aspect, the method includes measuring a mechanical resistance to the flow of a bulk metallic glass along the feed path (e.g. in step 712) and controlling a magnitude of the shearing force according to the mechanical resistance.

As shown in step 706, the method 700 may include extruding the build material. This may, for example, include supplying the build material from a source, driving the build material with a drive system, heating the build material in a reservoir, and extruding the build material through a nozzle of a printer as generally described herein.

As shown in step 708, the method 700 may include moving the nozzle relative to a build plate of the printer to fabricate an object on the build plate in a fused filament fabrication process based on a computerized model of the object, or otherwise depositing the build material in a layer-by-layer fashion to fabricate the object.

As shown in step 710, the method may include adjusting an exit shape of the nozzle. Where the nozzle includes an adjustable shape for extrusion as described herein, the shape may be periodically adjusted during fabrication according to, e.g., a desired feature size, a direction of travel of an extruder, and so forth. Thus, in one aspect, the method 700 may include varying a cross-sectional shape of an exit to the nozzle while extruding to provide a variably shaped extrudate during fabrication of the object. Varying the cross-sectional shape may include moving a plate relative to a fixed opening of a die to adjust a portion of the fixed opening that is exposed for extrusion, or applying any other mechanism suitable for controlling a cross-sectional profile of an extruder. In general, varying the cross-sectional shape may include varying at least one of a shape, a size and a rotational orientation of the cross-sectional shape.

In one aspect, the exit shape may be controlled with a number of concentric rings. For these embodiments, adjusting the exit shape may include selectively opening or closing each of the number of concentric rings while extruding to control an extrusion of one of the one or more build materials. Selectively opening or closing each of the number of concentric rings may further include opening or closing each of the number of concentric rings according to a location of the extrusion within the object, or according to a target volume flow rate of the extrusion.

As shown in step 712, the method 700 may include monitoring the deposition. This may include monitoring to obtain a feedback sensor for controlling the printing process, such as by sensing an electrical resistance at the interface between layers as described above. This may also or instead include logging data about the build process for future use.

As shown in step 714, the method 700 may include determining whether the current layer being fabricated by the printer is an interface to a support structure for a portion of the object, which may be an immediately adjacent layer of the support structure, an immediately adjacent layer of the object, or an interstitial layer between a layer of the support structure and a layer of the object. If the current layer is not an interface to a support structure, then the method 700 may proceed to step 716 where one or more techniques may be used to improve fusion to the underlying layer. If the current layer is an interface to a support structure, then the method 700 may proceed to step 718 where other techniques are used (or withheld from use) to reduce bonding strength between layers.

As shown in step 716, the method 700 may include fusing the deposition to an adjacent, e.g., directly underlying layer. This may employ a variety of techniques, which may be used alone or in any workable combination to strengthen the interlayer bond between consecutive layers of deposited build material.

For example, fusing the layers may include applying ultrasonic energy through the nozzle to an interface between the metallic build material exiting the nozzle and the metallic build material in a previously deposited layer of the object. Where, for example, electrical resistance at the interface is monitored, this may include controlling a magnitude of ultrasonic energy based on a bond strength inferred from the electrical resistance.

As another example, fusing the layers may include applying pulses of electrical current through an interface between the metallic build material exiting the nozzle and the metallic build material in a previously deposited layer of the object, e.g., to disrupt a passivation layer, soften the material and otherwise improve a mechanical bond between the layers. This process may be performed dynamically, e.g. by measuring a resistance at the interface and controlling the pulses of electrical current based on a bond strength inferred from the resistance. Thus in one aspect, the method 700 may include depositing a first layer of a metallic build material through a nozzle of a printer, depositing a second layer of a metallic build material through the nozzle onto the first layer to create an interface between the first layer and the second layer, and applying pulses of electrical current through the interface between the first layer and the second layer to disrupt a passivation layer on an exposed surface of the first layer of metallic build material and improve a mechanical bond across the interface. As the nozzle moves relative to a build plate of the printer to fabricate an object, the method may further include measuring a resistance at the interface and controlling the pulses of electrical current based on a bond strength inferred from the resistance.

As another example, fusing the layers may include applying a normal force on the metallic build material exiting the nozzle toward a previously deposited layer of the metallic build material with a former extending from the nozzle. This process may be performed dynamically, e.g., by measuring an instantaneous contact force between the former and the metallic build material exiting the nozzle with any suitable sensor, and controlling a position of the former based on a signal indicative of the instantaneous contact force.

As another example, fusing the layers may include joining a metallic build material as it exits a nozzle of an extruder to an underlying layer of the metallic build material within a plasma stream. In general, a plasma depassivation wash may be applied during deposition to reduce oxidation and improve interlayer bonding between successive layers of the metallic build material. This may be used with a metallic build material that includes a strong oxidizing element. Thus, for example, a plasma wash may usefully be employed when extruding a metallic build material including aluminum.

As shown in step 718, when a support interface is being fabricated, various techniques may be employed to weaken or reduce the bond between adjacent layers. In one aspect, this may include withholding any one or more of the fusion enhancement techniques described above with reference to step 716. Other techniques may also or instead be used to specifically weaken the fusion between layers in a support structure and an object.

Where the build material is a bulk metallic glass, a removable support structure may advantageously be fabricated by simply raising a temperature of the bulk metallic glass to crystallize the bulk metallic glass at the support interface during fabrication, or to melt the alloy so that it crystallizes upon resolidification. This technique can be used to fabricate a support structure, a breakaway support interface and an object from a single build material. In general, the support structure and the object may be fabricated from the bulk metallic glass at any temperature above the glass transition temperature. When manufacturing the interface layer between these other layers, the temperature may be raised to a temperature sufficiently high to promote crystallization of the bulk metallic glass within the time frame of the fabrication process.

Thus, in one aspect there is disclosed herein a method for fabricating an interface between a support structure and an object using a bulk metallic glass. The method may include fabricating a layer of a support structure for an object from a bulk metallic glass having a super-cooled liquid region at a first temperature above a glass transition temperature for the bulk metallic glass, fabricating an interface layer of the bulk metallic glass on the layer of support structure at a second temperature sufficiently high to promote crystallization of the bulk metallic glass during fabrication, and fabricating a layer of the object on the interface layer at a third temperature below the second temperature and above the glass transition temperature. It should be understood that “fabricating” in this context may include fabricating in a fused filament fabrication process or any other process that might benefit from the manufacture of breakaway support by crystallization of a bulk metallic glass. Thus, for example, a breakaway support structure may be usefully fabricated using these techniques in an additive manufacturing process based on laser sintering of bulk metallic glass powder, or any other additive process using bulk metallic glasses.

Similarly, there is disclosed herein a three-dimensional printer, which may be any of the printers described herein, that uses the above technique to fabricate support, an object, and an interface for breakaway support. Thus, there is disclosed herein a printer for three-dimensional fabrication of metallic objects, the printer comprising: a nozzle configured to extrude a bulk metallic glass having a super-cooled liquid region at a first temperature above a glass transition temperature for the bulk metallic glass; a robotic system configured to move the nozzle in a fused filament fabrication process to fabricate a support structure and an object based on a computerized model; and a controller configured to fabricate an interface layer between the support structure and the object by depositing the bulk metallic glass in the interface layer at a second temperature greater than the first temperature, the second temperature sufficiently high to promote crystallization of the bulk metallic glass during fabrication.

In another aspect, the interface between the support structure and the object may be deposited at a somewhat elevated temperature that does not substantially crystallize the interface, but simply advances the material in that region further toward crystallization within the TTT cooling curve than the remaining portions of the object and/or support. This resulting object may be subsequently heated using a secondary heating process (e.g., by baking at elevated temperature) to more fully crystallize the interface layer before the body of the object, thus leaving the object in a substantially amorphous state and the interface layer in a substantially crystallized state. Thus, the method may include partially crystallizing the interface layer, or advancing the interface layer sufficiently toward crystallization during fabrication to permit isolated crystallization of the interface layer without crystallizing the object in a secondary heating process.

In another aspect, the interface may be inherently weakened by fabricating the support structure and the object from two thermally mismatched bulk metallic glasses. By using thermally mismatched bulk metallic glasses for an object and adjacent support structures, the interface layer between these structures can be melted and crystallized to create a more brittle interface that facilitates removal of the support structure from the object after fabrication. More specifically, by fabricating an object from a bulk metallic glass that has a glass transition temperature sufficiently high to promote crystallization of another bulk metallic glass used to fabricate the support structure, the interface layer can be crystallized to facilitate mechanical removal of the support structure from the object simply by depositing the first material (used to fabricate the object) adjacent to the second build material (used to fabricate the support structure).

Thus, in one aspect, there is disclosed a method for controlling a printer in a three-dimensional fabrication of a metallic object using a bulk metallic glass, and more specifically for using two different bulk metallic glasses with different working temperature ranges to facilitate fabrication of breakaway support structures. The method may include the steps of fabricating a support structure for an object from a first bulk metallic glass having a first super-cooled liquid region, and fabricating an object on the support structure from a second bulk metallic glass different than the first bulk metallic glass, where the second bulk metallic glass has a glass transition temperature sufficiently high to promote a crystallization of the first bulk metallic glass during fabrication, and where the second bulk metallic glass is deposited onto the support structure at a temperature at or above the glass transition temperature of the second bulk metallic glass to induce crystallization of the support structure at an interface between the support structure and the object. The printer may be a fused filament fabrication device, or any other additive manufacturing system suitable for fabricating a support from a first bulk metallic glass and an object from a second bulk metallic glass in a manner consistent with crystallization of the interface as contemplated herein.

As with the single-material technique described above, the resulting object and support structure may be subjected to a secondary process to heat and fully crystallize the interface layer interposed between these two.

The second bulk metallic glass may have a glass transition temperature above a critical crystallization temperature of the first bulk metallic glass, and the method may include heating the second bulk metallic glass to a second temperature above the critical crystallization temperature of the first bulk metallic glass before deposition onto the first bulk metallic glass. The crystallization of the first bulk metallic glass may usefully yield a fracture toughness at the interface not exceeding twenty MPa√m. While the interface layer and some adjacent portion of the support structure may be usefully fabricated from the first bulk metallic glass to facilitate crystallization of the interface layer, underlying layers of the support structure may be fabricated from a range of other, potentially less expensive, materials. Thus, in one aspect fabricating the support structure may include fabricating a base of the support structure from a first material, and an interface layer of the support structure between the base and the object from the first bulk metallic glass. The method may also generally include removing the support structure from the object by fracturing the support structure at the interface where the first bulk metallic glass is crystallized.

Many systems of glass forming alloys may be used to obtain thermally mismatched pairs suitable for fabricating a brittle interface layer. For example, the low-temperature support structure may be fabricated from a magnesium-based bulk metallic glass. The magnesium-based metallic glass for supports may, for example, contain one or more of calcium, copper, yttrium, silver and gadolinium as additional alloying elements. The magnesium-based glass may, for example, have the composition: Mg₆₅Cu₂₅Y₁₀, Mg₅₄Cu₂₈Ag₇Y₁₁. The object may be fabricated from a relatively high-temperature bulk metallic glass containing, e.g., zirconium, iron, or titanium-based metallic glass. For example, the high-temperature alloy may include a zirconium-based alloy containing one or more of copper, and may contain copper, nickel, aluminum, beryllium or titanium as additional alloying elements. As more specific examples, a zirconium-based alloy may include any one of Zr₃₅Ti₃₀Cu_{8.25}Be_{26.7}, Zr₆₀Cu₂₀Ni₈Al₇Hf₃Ti₂, or Zr₆₅Cu_{17.5}Ni₁₀Al_{7.5}. An iron-based high-temperature alloy may include (Co_{0.5}Fe_{0.5})₆₂Nb₆Dy₂B₃₀, Fe₄₁Cr₁₅Co₇C₁₂B₇Y₂ or Fe₅₅Co₁₀Ni₅Mo₅P₁₂C₁₀B₅. Still more specifically, a useful pair of alloys include Zr_{58.5}Nb_{2.8}Cu_{15.6}Ni_{12.8}Al_{10.3} with a glass transition temperature of about four hundred degrees Celsius and Zr₄₄Ti₁₁Cu₁₀Ni₁₀Be₂₅ with a glass transition temperature of about three-hundred fifty degrees Celsius. As another example, Fe₄₈Cr₁₅Mo₁₄Er₂C₁₅B₆ has a glass transition temperature of about five-hundred seventy degrees Celsius and Zr₆₅Al₁₀Ni₁₀Cu₁₅ has a glass transition temperature of about three-hundred seventy degrees Celsius, thus providing approximately a two-hundred-degree processing margin, which may be useful, for example, in contexts where substantial cooling takes place shortly after deposition.

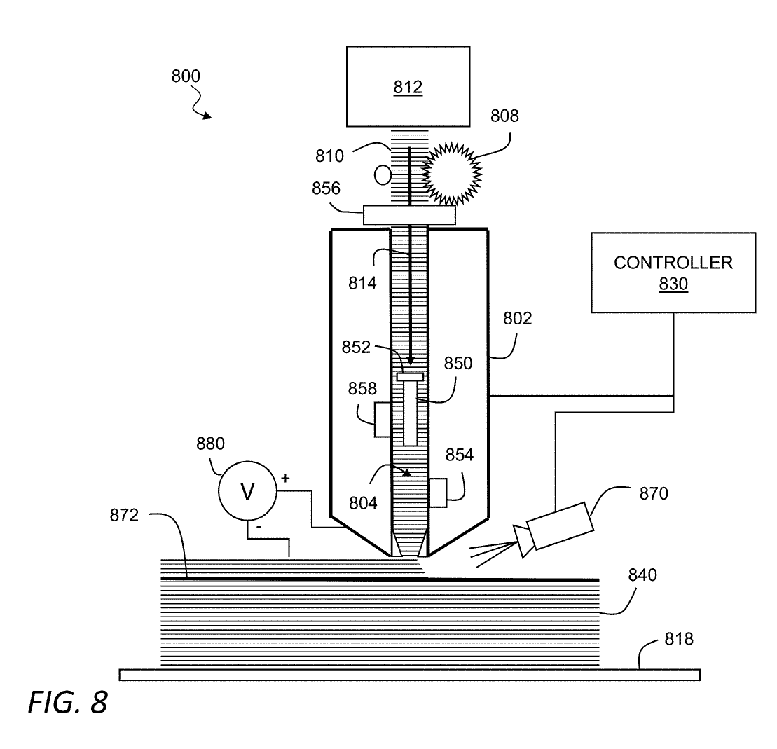

FIG. 8 shows an extruder for a three-dimensional printer. In general, an extruder 800 for a printer such as a bulk metallic glass printer may include a source 812 of a build material 810 that is advanced by a drive system 808 through a reservoir 804 and out the opening 816 of a nozzle 802 to form an object 840 on a build plate 818, all as generally described herein. A controller 830 may control operation of the extruder 800 and other printer components to fabricate the object 440 from a computerized model. The extruder 800 may include various features alone or in combination to facilitate improved material handling or layer formation and fusion. For example, the extruder 800 may include a shearing engine 850, and the extruder may also or instead include a plasma source 870.

A shearing engine 850 may be provided within the feed path for the build material 810 (e.g., a bulk metallic glass) to actively induce a shearing displacement of the bulk metallic glass to mitigate crystallization or formation of agglomerations of solidified metal. This may advantageously extend a processing time for handling the bulk metallic glass at elevated temperatures. In general, the shearing engine 850 may include any mechanical drive configured to actively induce a shearing displacement of a flow of the bulk metallic glass along the feed path 814 through the reservoir 804 to mitigate crystallization of the bulk metallic glass while above the glass transition temperature.

In one aspect, the shearing engine 850 may include an arm 852 positioned within the reservoir 804. The arm 852 may be configured to move and displace the bulk metallic glass within the reservoir 804, e.g., by rotating about an axis of the feed path 814. The shearing engine may include a plurality of arms, such as two, three or four arms, which may be placed within a single plane transverse to the axis of the feed path 814, or staggered along the axis to encourage shearing displacement throughout the axial length of the reservoir 804. The shearing engine 850 may also or instead include one or more ultrasonic transducers 854 positioned to introduce shear within the bulk metallic glass 810 in the reservoir 804. The shearing engine 850 may also or instead include a rotating clamp 856. The rotating clamp 856 may be any combination of clamping or gripping mechanisms mechanically engaged with the bulk metallic glass 810 as the bulk metallic glass 810 enters the reservoir 804 at a temperature below the glass transition temperature and configured to rotated the bulk metallic glass 810 to induce shear as the bulk metallic glass 810 enters the reservoir 804. This may for example include a collar clamp, a shaft collar or the like with internal bearings to permit axial motion through the rotating clamp 856 while preventing rotational motion within the clamp. By preventing rotational motion, the rotating clamp 856 can exert rotational force on the build material 810 in solid form. The source 812 of build material 810 may also rotate in a synchronized manner to prevent an accumulation of stress within the build material 810 from the source that might mechanically disrupt the build material 810 as it travels from the source 812 to the reservoir 804.

The shearing engine 850 may be usefully controlled according to a variety of feedback signals. In one aspect, the extruder 800 may include a sensor 858 to detect a viscosity of the build material 810 (e.g., bulk metallic glass) within the reservoir 804, and the controller 830 may be configured to vary a rate of the shearing displacement by the shearing engine 850 according to a signal from the sensor 858 indicative of the viscosity of the bulk metallic glass. This sensor 858 may, for example, measure a load on the drive system 808, a rotational load on the shearing engine 850, or any other parameter directly or indirectly indicative of a viscosity of the build material 810 within the reservoir 804. In another aspect, the sensor 858 may include a force sensor configured to measure a force applied to the bulk metallic glass 810 by the drive system 808, and the controller 830 may be configured to vary a rate of the shearing displacement by the shearing engine 850 in response to a signal from the force sensor indicative of the force applied by the drive system 850. In another aspect, the sensor 858 may be a force sensor configured to measure a load on the shearing engine 850, and the controller 830 may be configured to vary a rate of the shearing displacement by the shearing engine in response to a signal from the force sensor indicative of the load on the shearing engine 850. In general, crystallization may be inferred when a viscosity of the bulk metallic glass above the glass transition temperature exceeds about 10̂12 Pascal-seconds. Any suitable mechanism for directly or indirectly measuring or estimating viscosity for comparison to this threshold may be usefully employed to provide a sensor signal for controlling operation of the shearing engine 850 as contemplated herein.

The extruder 800 may also or instead include a plasma source 870. The plasma source 870 may be directed at the metallic build material 810 exiting through the nozzle 802 to provide a depassivation wash that removes or mitigates an oxidation layer and other potential contaminants that might interfere with layer-to-layer bonding of the build material 810 within the object 840, more specifically by directing a stream of plasma at a location on the interface 872 between successive layers where the metallic build material exiting the nozzle joins an underlying layer of the previously deposited metallic build material while material is being deposited. In another aspect, the plasma source 870 may be directed at a location on the underlying layer before the metallic build material exiting the nozzle is deposited over the location, effectively providing a pre-wash of the surface that is about to receive the build material. While strong oxidizers such as aluminum may more preferably be exposed to the plasma immediately while the layer is forming, other contaminants may usefully be removed with a pre-wash process. The plasma source 870 may be steerable or otherwise controllable by the controller 830 to provide a desired intensity and direction of plasma wash during fabrication. The plasma source 870 may generate plasma using any suitable techniques. For example, the plasma source 870 may include a variable chemistry plasma source, an ion plasma source, or any other commercially available or proprietary plasma source suitable for deployment within a build chamber of a three-dimensional printer as contemplated herein.

In one aspect, the extruder 800 may include a voltage monitoring circuit 880 which may be used to measure a voltage difference between, e.g., the nozzle 802 (where the nozzle 802 is metallic or conductive) and the build material 810 where it is exiting the nozzle. As noted above, this potential difference may be used in combination with information about Seebeck coefficients for the nozzle material and the build material 810 to calculate a temperature difference between the two materials according to the following relationship:

$${S}_{AB} = {S}_{A} - {S}_{B} = \frac{{V}_{A} - {V}_{B}}{{T}_{A} - {T}_{B}}$$

Where A and B denote the materials of the nozzle 802 and the build material 810, S denotes relative or specific Seebeck coefficients, V denotes a voltage, and T denotes a temperature.

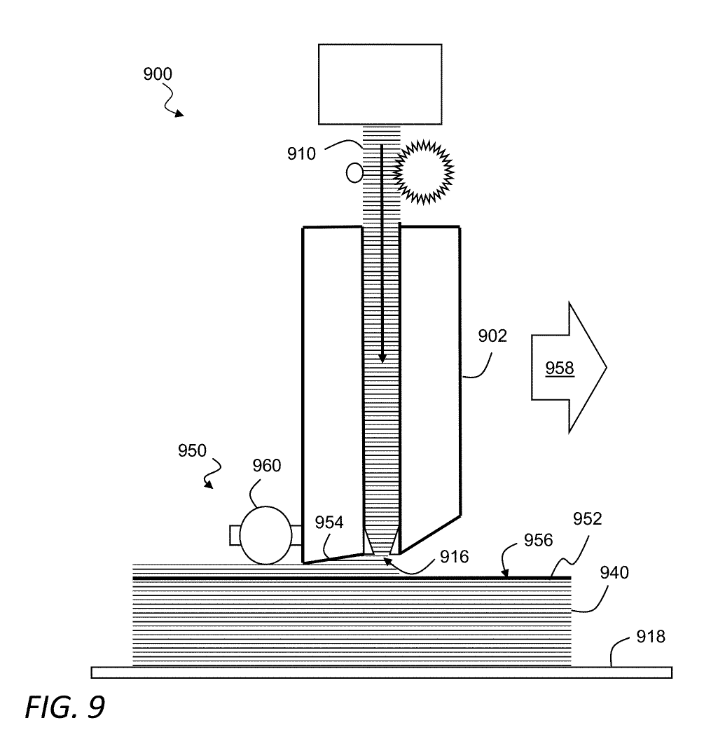

FIG. 9 shows an extruder for a three-dimensional printer. In general, an extruder 900 such as any of the extruders described above may include a former 950 extending from the nozzle 902 to supplement a layer fusion process by applying a normal force toward a previously deposited layer 952 of the build material 910 as the build material 910 exits the nozzle 902.

In one aspect, the former 950 may include a forming wall 954 with a ramped surface that inclines downward from the opening 916 of the nozzle 902 toward the surface 956 of the previously deposited layer 952 to create a downward force as the nozzle 902 moves in a plane parallel to the previously deposited surface 956, as indicated generally by an arrow 958. The forming wall 954 may also or instead present a cross-section to shape the build material 910 in a plane normal to a direction of travel of the nozzle 902 as the build material 910 exits the nozzle 902 and joins the previously deposited layer 952. This cross-section may, for example include a vertical feature such as a vertical edge or curve positioned to shape a side of the build material as the build material exits the opening. With a vertical feature of this type, the forming wall 954 may trim and/or shape bulging and excess deposited material to provide a well-formed, rectangular cross-sectional shape to roads of material deposited in a fused filament fabrication process, which may improve exterior finish of the object 940 and provide a consistent, planar top surface 956 to receive a subsequent layer of the build material 910.

The former 950 may also or instead include a roller 960 positioned to apply the normal force. The roller 960 may be a heated roller, and may include a rolling cylinder, a caster wheel, or any other roller or combination of rollers suitable for applying continuous, rolling normal force on the deposited material.

In one aspect, a non-stick material having poor adhesion to the build material may be disposed about the opening 916 of the nozzle 902, particularly on a bottom surface of the nozzle 902 about the opening 916. For metallic build materials, useful non-stick materials may include a nitride, an oxide, a ceramic, or a graphite. The non-stick material may also include any material with a reduced microscopic surface area that minimizes loci for microscopic mechanical adhesion. The non-stick material may also or instead include any material that is poorly wetted by the metallic build material.

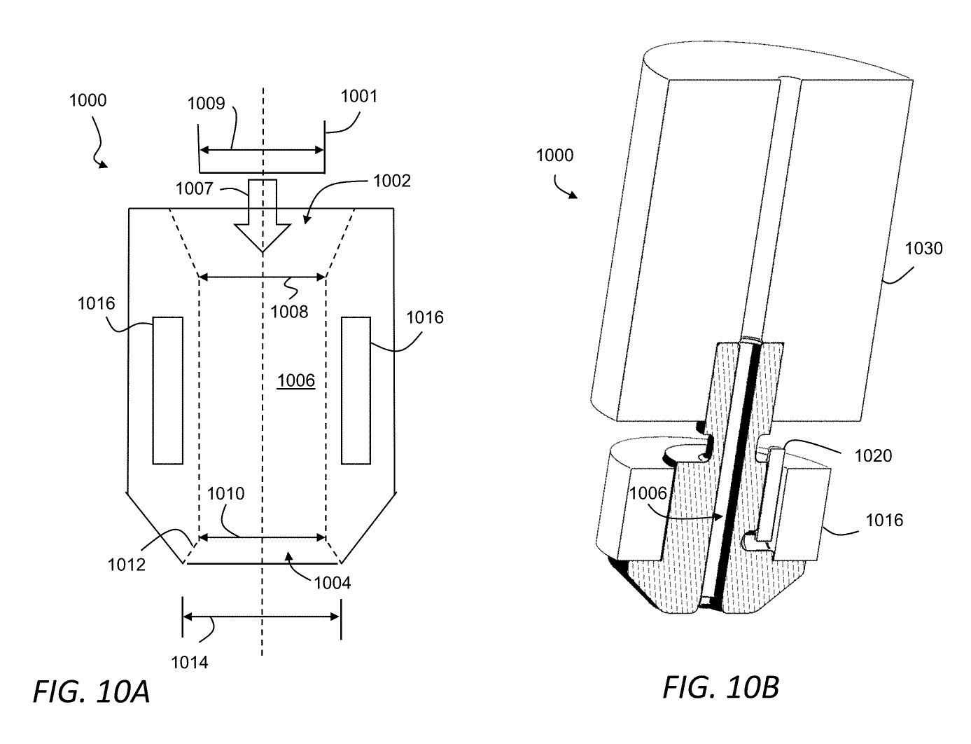

FIG. 10A shows a spread forming deposition nozzle. As generally described herein, a printer may fabricate an object from a build material based on a computerized model and a fused filament fabrication process. A nozzle 1000 for depositing a build material 1001 may be modified as described herein to improve flow and deposition characteristics. Generally, the nozzle 1000 may have an exit with an interior diameter that approaches an outer diameter of build material 1001 fed to the nozzle 1000 in order to reduce extrusion and resistance forces imposed by the nozzle 1000 during deposition, while adequately constraining a planar position of the build material for accurate material deposition in a computer-controlled fabrication process.

In general, the nozzle 1000 may include a first opening 1002, a second opening 1004, and a reservoir 1006 coupling the first opening to the second opening.

The first opening 1002 may have a variety of shapes. Where a build material 1001, which may include any of the build materials described herein, has a substantially circular cross section, the first opening 1002 may have a circular cross section as well, and the first opening 1002 that receives the build material 1001 may have a first inside diameter 1008 at least as great as an outside diameter 1009 of the build material 1001. The first inside diameter 1008 is preferably slightly greater than the outside diameter 1009 of the build material 1001 to avoid binding or friction as the build material 1001 enters the first opening 1002 of the reservoir 1006. It will be understood that above the first opening 1002, e.g., earlier in a feedpath 1007 for the build material 1001, the nozzle 1000 may include a funnel or other opening that gradually or suddenly increases in size in order to receive the build material 1001 and guide the build material 1001 as it advances along the feedpath 1007 toward the first opening 1002. The size and shape of this entrance may vary according to the feedstock. For example, where the feedstock is a thin, flexible filament fed into the first opening 1002 from a distance, the entrance may form a relatively large, wide, and long funnel to progressively guide the feedstock toward the opening. Conversely, where the feedstock is rigid and provided in linear segments, only a slight alignment may be required at the first opening 1002, and the entrance may be adequately formed from a small bevel or chamfer at a leading edge of the first opening 1002.

The second opening 1004 generally has a second inside diameter 1010, which may be positioned at an opposing end of the reservoir 1006 from the first opening 1002 to deposit the build material 1001 on a surface (such as a build plate or a surface of an object being fabricated) in a fabrication process as the build material 1001 exits the reservoir 1006. The second inside diameter 1010 will generally be a point of narrowest constriction for the build material 1001 along the feedpath 1007 through the reservoir 1006, although in some embodiments the reservoir 1006 may include slightly narrower diameters at interior locations. While a conventional fused filament fabrication nozzle will substantially restrict a diameter of extruded build material, e.g. from 1.75 mm down to 0.4 mm or less, at an exit point, it has been determined that the exit port may usefully be maintained at about the same dimensions as the build material 1001 and/or the entrance opening (the first opening 1002) for the nozzle 1000. Thus, for example the second inside diameter 1010 of the second opening 1004 may be not less than ninety percent of the first inside diameter 1008, or more generally less than the first inside diameter 1008, e.g., with just enough restriction to align and secure the exiting build material 1001 in the x-y plane of a fabrication process. Where the build material 1001 expands radially within the reservoir, the second opening 1004 may also be slightly larger than the first opening 1002. Thus, in one aspect, the second inside diameter 1010 of the second opening 1004 may be not less than the first inside diameter 1008, or slightly larger than the first inside diameter 1008. Regardless of the specific dimensions, it may be generally advantageous for the build material 1001 to at least slightly contact the second opening 1004 at the exit in order to align the deposition of build material 1001 to a fabrication process, and to maintain physical contact between the build material 1001 and the interior walls of the nozzle 1000 to maintain heat transfer from a heating system 1016.

It will be understood that the first opening 1002 and the second opening 1004 may also or instead be configured for non-circular cross-sectional geometries of filament or other feedstock. Thus, where the feedstock has a more generalized cross-sectional shape, the first opening 1002 may have a first shape to accommodate the cross-sectional shape (e.g., equal or larger in all dimensions) and the second opening 1004 may have a second shape with one or more interior dimensions smaller than the first shape and a cross-sectional area not less than ninety percent of the first shape. The general notion is to very slightly constrict the build material 1001 in all directions within an x-y plane as the build material exits the second opening 1004, and it should be understood that a wide variety of dimensional restrictions may usefully achieve this objective, including a slight downward scaling of the cross-sectional shape from the first opening 1002 to the second opening 1004, or a scaling of one or more specific dimensions. In this generalized configuration, the second opening 1004 can contact the build material 1001 about a perimeter of the cross-sectional shape as the build material 1001 passes through the second opening 1004 to resist movement of the build material in an x-y plane normal to a z-axis of the printer.

The second opening 1004 may usefully include a chamfered edge 1012 or any similarly beveled or angled surface or the like at an exit to the nozzle 1000 so that the second opening 1004 flares or similarly widens downstream of the second inside diameter 1010 to a third inside diameter 1014, which may, for example, be greater than the first inside diameter 1002. This chamfered edge 1012 may avoid binding at the trailing edge of the nozzle 1000 (relative to a build path) where deposited material might otherwise be forced backward and upward into a trailing interior surface of the second opening 1004.

A heating system 1016 may be positioned along the feedpath, e.g., adjacent to the reservoir 1006 between the first opening 1002 and the second opening 1004 in order to heat the build material 1001 in the reservoir 1006 to within a working temperature range as generally contemplated herein. This may include resistive heating elements, inductive heating elements, or any of the other heating elements, systems or devices described herein. In general, the heating system 1016 may heat the build material 1001 to a working temperature suitable for extrusion through the second opening 1004 and bonding to the surface that receives the build material 1001 from the nozzle 1000.

The nozzle 1000 may be associated with a fused filament fabrication system or similar extrusion-based or deposition-based additive manufacturing device, such as any of the systems described herein. Thus, while not depicted in this figure, it will be appreciated that the nozzle 1000 may be associated with a build platform to receive an object fabricated with the printer, a robotic system configured to move the nozzle relative to the build platform while depositing the build material 1001 from the second opening 1004, and a processor configured to control the printer to fabricate the object on the build platform from a three-dimensional model of the object. Other features may also or instead be included, such as a build chamber enclosing the build platform and the object within a controlled environment.

In another aspect, the nozzle 1000 may include a local heating system such as any of the heating systems described herein for heating the build material as it exits the second opening 1004 of the nozzle 1000. This local heating system may help to soften the build material 1001 for improved deposition, spreading, and/or fusion with an underlying layer. This may, for example, include at least one of a joule heating system configured to pass current through the build material 1001 across an interface between a first layer of the build material 1001 exiting the nozzle 1000 and an underlying layer of the build material 1001, a laser heating system configured to heat the build material 1001 in an area around the second opening, and a resistive heating system within the nozzle 1000 near the second opening 1004. In another aspect, the heating system 1016 may pre-heat the build material 1001 to a temperature above an ambient temperature but below a working temperature range for the build material within the reservoir 1006, and the local heating system may subsequently heat the build material 1001 from this intermediate temperature to a second temperature within the working temperature range as the build material 1001 exits the nozzle 1000. As described herein, the working temperature range may include any range of temperatures where the build material 1001 exhibits rheological properties suitable for extrusion, which may vary from material to material, as well as from system to system. For certain materials, extrusion from a wide-bore nozzle such as the nozzle 1000 described in reference to FIG. 10A may be usefully performed at lower temperatures than a more restrictive, conventional nozzle because the larger opening produces smaller axial loads.

There foregoing techniques may also be combined with one another, or with other techniques described herein. For example, a printer may move the nozzle 1000 in a path within an x-y plane of a build volume of the printer during deposition, and the nozzle 1000 may include a local heater to provide energy to heat the build material on a leading edge of the nozzle relative to the path, while an ironing shoe on a trailing edge of the nozzle relative to the path applies a normal force to the build material into an underlying layer of material.

A fabrication method may usefully incorporate the nozzle 1000 of FIG. 10A. This method may, for example, include providing a build material formed as a filament having a cross-sectional shape and a cross-sectional area, heating the build material to a working temperature, driving the build material through an opening having a second cross-sectional shape substantially similar to the cross-sectional shape of the filament and an area not more than ten percent less than the cross-sectional shape of the filament; and depositing the build material through the opening along a path to form a three-dimensional object from the build material. Numerous other fabrication methods and steps described herein may also or instead be included in a fabrication process using the nozzle 1000 described above.

FIG. 10B shows a spread forming deposition nozzle. In general, the nozzle 1000 may include a heating system 1016, a reservoir 1006, a temperature sensor 1020 and a heat sink 1030. As described above, the reservoir 1006 may have a generally uniform cross-sectional shape. While the reservoir 1006 may contain modest constrictions as discussed above, and the reservoir 1006 may include modest expansions, e.g., with an inlet taper (between the heat sink 1030 and the reservoir 1006) and an outlet taper as illustrated, The reservoir 1006 does not contain any substantial restriction that requires extrusion of the build material through a die or the like, or any other similarly restrictive opening that imposes substantial extrusion-related loads on a drive system for an associated printer.

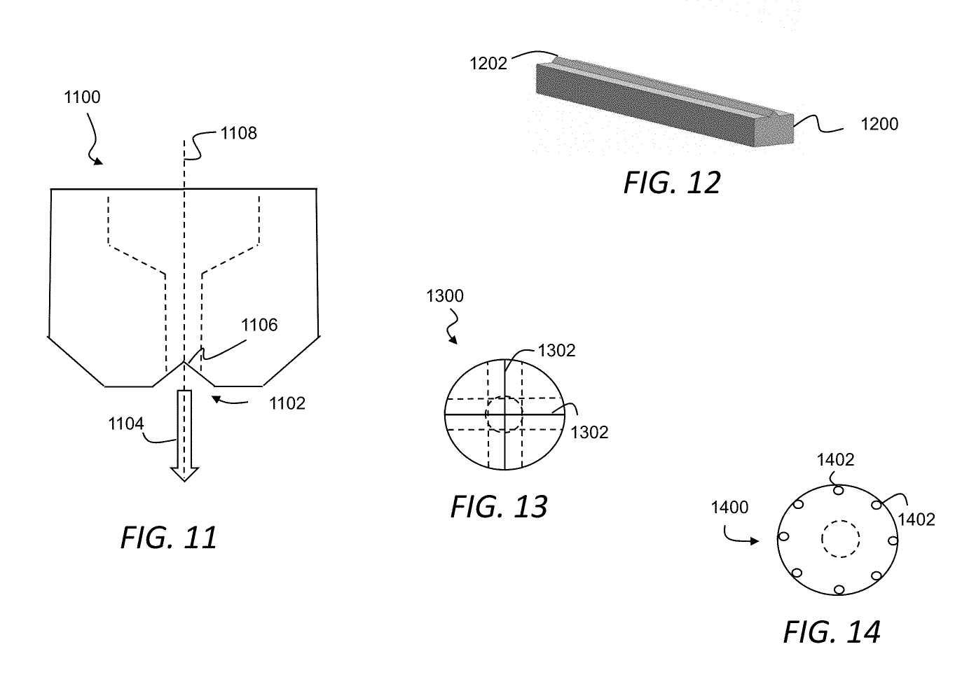

FIG. 11 shows a cross section of a nozzle for fabricating energy directors. As a build material exits the nozzle 1100, one or more energy directors such as ridges may be formed in an exposed surface of the deposited build material to provide regions of high, localized contact force that can improve interlayer bonding between successive layers of the build material. Other techniques such as ultrasonic vibration may also be used to improve fusion along these energy director features.

In general, the nozzle 1100 may include a shaping fixture 1102 to impose at least one ridge on a top surface of a build material, such as a metallic build material, as it exits the nozzle 1100 in a direction indicated by an arrow 1104. The shaping fixture 1102 may, for example, include a groove 1106 passing through a central axis 1108 of the nozzle 1100, which may rotate to aligned to a direction of travel of the nozzle 1100, either actively or passively, or which may remain rotationally fixed so that the nozzle 1100 only creates energy director features when the nozzle 1100 travels in certain directions within an x-y plane. Thus, in one aspect, the shaping fixture 1102 may rotate about the central axis 1108 of the nozzle 1100 to align the shaping fixture 1102 to the build path as the build path changes direction within an x-y plane of the fabrication process.

As with other nozzles described herein, the nozzle 1100 may be incorporated into an additive fabrication system such as a system including a robotic system operable to move the nozzle 1100 through a build path relative to a build platform to form an object in a fabrication process. Other useful features may include a roller trailing the nozzle along the build path that applies a downward normal force and an ultrasound energy to a subsequent layer as it is deposited over the at least one ridge. The system may more generally include a build plate, a heating system and a robotic system, the robotic system configured to move the nozzle in a three-dimensional path relative to the build plate in order to fabricate an object from a build material on the build plate according to a computerized model of the object, as well as a controller configured by computer executable code to control the heating system, the drive system, and the robotic system to fabricate the object on the build plate from the metallic build material.

FIG. 12 shows an energy director formed in a layer of deposited build material. In general, a bead or road of build material 1200 may be deposited using any of a number of techniques described herein. A nozzle such as the nozzle described in FIG. 11 may be employed to form a ridge 1202 or similar feature with raised, small-surface-area features that direct energy into localized areas to improve inter-layer fusion during contact with a subsequent layer.

FIG. 13 shows a top view of a nozzle exit with multiple grooves. As described above, a nozzle 1300 may include a number of groove 1302 such as those illustrated above, or similar shaping features passing through a central axis of the nozzle 1300 at different angles. This arrangement advantageously permits the creation of energy director features when traveling in a greater number of directions in an x-y plane without requiring that the nozzle 1300 rotate about the central axis. While the grooves in the drawing are depicted as passing through the central axis of a nozzle 1300, this is not required. Any number of grooves may be incorporated that do not pass through the central axis, including multiple parallel grooves or multiple grooves at different angles to the central axis.

FIG. 14 shows a top view of a nozzle exit with a number of protuberances. In general, the shaping fixture of the nozzle 1400 may include one or more protuberances 1402 such as fingers, rods, or the like extending down from the nozzle toward a build surface and positioned to form valleys (and corresponding peaks) in the top surface of the build material exiting the nozzle by raking or otherwise shaping the surface while material is deposited.

An additive fabrication method may usefully incorporate the nozzles described above to form energy directors in an exposed surface of a build material. For example, a method for controlling a printer in a three-dimensional fabrication of an object as contemplated herein may include extruding a build material through a nozzle of the printer, moving the nozzle along a build path relative to a build plate of the printer to fabricate an object on the build plate in a fused filament fabrication process based on a computerized model of the object, and shaping a top surface of the build material as it exits the nozzle to form one or more ridges providing regions of high localized contact force to receive a subsequent layer of the build material. The method may use any of the build materials described herein, and may usefully incorporate other techniques for improving inter-layer fusion, such as applying ultrasound energy to the subsequent layer of the build material while it is deposited over the one or more ridges, or applying a plasma stream to the one or more ridges while depositing the subsequent layer.

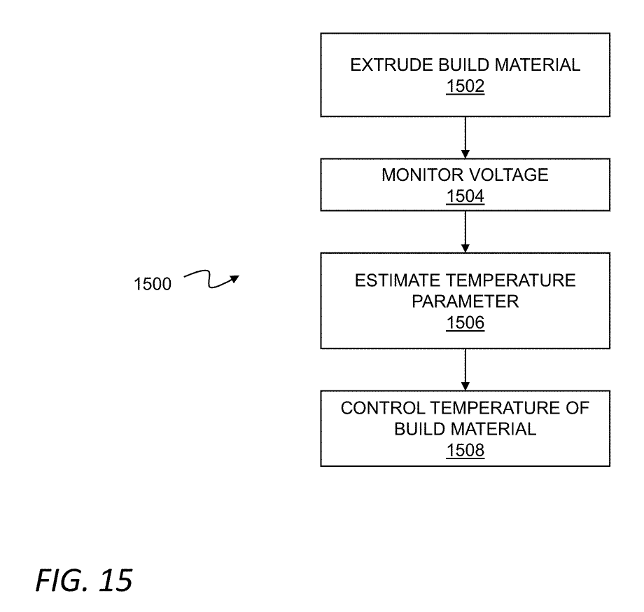

FIG. 15 illustrates a method for monitoring temperature with the Seebeck effect. The Seebeck effect is a phenomenon in which a temperature difference between two dissimilar electrical conductors or semiconductors produces a voltage difference between the two materials. This property may be harnessed to infer build material temperatures even where the material temperature is not amenable to direct measurement, such as where the build material exits a nozzle formed of an electrically conducting material. It will be understood that, while the following description specifically refers to the Seebeck effect, a number of thermodynamically related notions such as the Peltier effect and the Thomson effect, which collectively travel under the name of the thermoelectric effect, describe phenomena in which temperature differences are converted into electrical voltage or vice versa, any of which may be equivalently applied to measure temperatures as contemplated herein.

As shown in step 1502, the method 1500 may include extruding a build material in a fabrication process. This may, for example, include extruding a metallic build material through a nozzle of the printer and moving the nozzle along a build path relative to a build plate of the printer to fabricate an object on the build plate in a fused filament fabrication process based on a computerized model of the object using any of the techniques described herein.

As shown in step 1504, the method 1500 may include monitoring a voltage between the nozzle and the metallic build material. This may include monitoring the voltage using any of the various circuits and probe placements discussed herein provided that the voltage measurement spans the physical interface between the two different materials of the nozzle and the build material, which is where the Seebeck effect will create a voltage differential based on the temperature difference.

As shown in step 1506, the method 1500 may include estimating a temperature parameter of the metallic build material based upon the voltage. The temperature parameter may be any indicator of temperature useful for controlling a heating system. For example, the temperature parameter may include a relative temperature between the nozzle and a metallic build material, which is the most direct result obtained from the Seebeck relationship. However, the absolute temperature of the metallic build material may be more useful measurement for controlling a heating system. Thus, in one aspect, the temperature parameter may include an absolute temperature of the metallic build material. In order to obtain the absolute temperature, the method 1500 may include measuring a temperature of the nozzle, e.g. with an external thermocouple, an infrared scanner, or any other suitable technique, and then estimating a temperature difference between the nozzle and the metallic build material based on the voltage and a Seebeck coefficient for each of the metallic build material and a material of the nozzle. These two values—the absolute temperature of the nozzle and the temperature differential between the nozzle and the build material—can be summed together to calculate the absolute temperature of the build material.

As shown in step 1508, the method 1500 may include controlling a temperature of the metallic build material in response to the temperature parameter. A variety of techniques for controlling temperature are described herein, any of which may be suitably adapted for use in controlling the temperature of the metallic build material. For example, controlling the temperature may include controlling an extrusion rate of the build material to increase or decrease heat transfer from a heating system to the build material as the build material passes through the nozzle. Controlling the temperature may also or instead include controlling a heating system that provides heat to the build material as it travels along the feedpath, or controlling a nozzle speed to mitigate localized heating where material is deposited. In another aspect, any of the local heating techniques described herein may be employed at the exit of the nozzle to more locally control the temperature of the extruded material, e.g., with laser heating, a stream of cooling fluid, joule heating, and so forth. More generally, by providing rapid and accurate direct measurements of a thermal parameter for the build material using the Seebeck effect, as distinguished from inferential measurements of surrounding hardware, improved thermal control may be achieved.

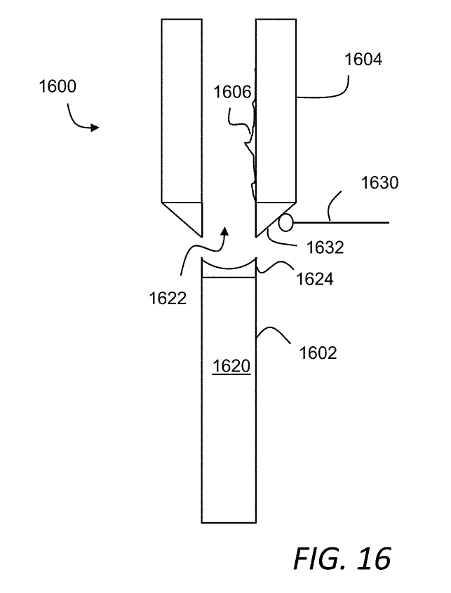

FIG. 16 shows an extruder for a three-dimensional printer. The extruder 1600 may include a nozzle 1604, such as any of the nozzles described herein, along with a nozzle cleaning fixture 1602.

The nozzle cleaning fixture 1602 may be positioned at any suitable location within a build chamber of a printer (or near the build chamber) where the nozzle cleaning fixture 1602 can be accessed by the nozzle 1602 using the robotic system of the printer, such as on a build plate for the printer. In general, the nozzle cleaning fixture 1602 may be shaped to physically dislodge or machine solidified build material and other contaminants from the nozzle 1600, and a robotic system for the printer can be used to maneuver the nozzle 1604 into engagement with the nozzle cleaning fixture 1602 for periodic cleaning, or in response to a diagnostic condition or the like indicating a clogged nozzle. A controller for the printer may accordingly be configured to move an opening of the nozzle 1604 into engagement with the nozzle cleaning fixture 1602 to dislodge obstructions 1606 to the exit path such as hardened metal, contaminants, and so forth. This may include moving the nozzle 1604 to the nozzle cleaning fixture 1602, moving the nozzle cleaning fixture 1602 to the nozzle 1604, or some combination of these.

In general, the nozzle cleaning fixture 1602 may be geometrically matched to an exit of the nozzle 1604. For example, the nozzle cleaning fixture 1602 may include a pin 1620 or the like shaped to mechanically dislodge obstructions to the exit path when the opening 1622 is placed over the pin 1620. More generally, any suitably complementary geometries may be employed. For example, if the nozzle 1604 has a non-circular cross-sectional bore, then a complementary shape may be used for the pin. The nozzle cleaning fixture 1602 may usefully integrate a sharpened edge 1624 positioned to remove material from the opening as the pin 1620 engages with the opening 1622.

In one aspect, the nozzle cleaning fixture 1602 may include a current source such as any of the joule heating systems described herein to apply a joule heating current through metallic build material within the opening 1622 in order to melt and flow the metallic build material through the nozzle 1604. This may usefully liquefy any crystallized, hardened, or otherwise lodged build material or contaminants so that they can be flowed out of the nozzle 1604. The nozzle cleaning fixture 1602 may also or instead include a microwave energy source configured to heat the metallic build material above a melting temperature.

A controller for the printer may selectively apply the nozzle cleaning fixture 1602 in a number of manners. For example, the controller may be configured to move the opening 1622 of the nozzle 1604 into engagement with the nozzle cleaning fixture 1602 according to a predetermined nozzle cleaning schedule, or in response to a detection of a potential obstruction to a flow through the nozzle, or some combination of these.

In another aspect, the extruder 1600, or a printer that uses the extruder 1600, may include a contact probe 1630 configured to electronically detect a contact of the contact probe with a surface 1632 of the nozzle, the contact probe 1630 positioned to contact the surface of the nozzle at a predetermined location. More generally, one or more contact probes may be used to detect a height and/or position of a nozzle, e.g., to zero, center, or otherwise calibrate the nozzle prior to a print, or to determine a height relative to a deposited layer of build material during fabrication. The predetermined location may, for example, include a predetermined location within a build volume of the printer such as a specific x-y-z coordinate, or a particular z-axis location within the build volume. The predetermined location may also or instead include a relative position such as a predetermined height relative to a build platform of the printer, a predetermined height relative to a layer of the metallic build material previously deposited from the nozzle in a fabrication process, or a predetermined height relative to a layer of the metallic build material currently being deposited from the nozzle in a fabrication process. By using a surface 1630 of the nozzle 1600 that faces downward, z-axis measurements may readily be captured by lowering the nozzle 1600 toward the contact probe 1630 until electrical contact is detected.

In general, a processor or other controller of the printer may be configured to respond to the contact with one or more position-based control signals. For example, the processor may be configured to calibrate a position of one or more motors in a robotic system that moves the nozzle within the build volume of the printer based on a detection of the contact with the surface of the nozzle. Although a single contact probe 1630 is illustrated, it will be appreciated that multiple contact probes 1630 may also be employed, either to facilitate different types of position measurements, or to improve x-y-z resolution of a particular measurement. Thus, for example, a printer may include a plurality of contact probes 1630 and the processor may be configured to center the nozzle 1604 based on a concurrent contact with each of the plurality of contact probes 1630. In another aspect, the printer may include a second contact probe 1630 coupled in a fixed alignment with the contact probe 1630. These probes 1630 may be controllably positionable within a build volume of the printer, and the processor may be configured to position the second contact probe in contact with an exposed top surface of the metallic build material deposited to form an object, and to determine a height of the nozzle relative to the exposed top surface based upon the contact of the first contact probe with the surface of the nozzle.

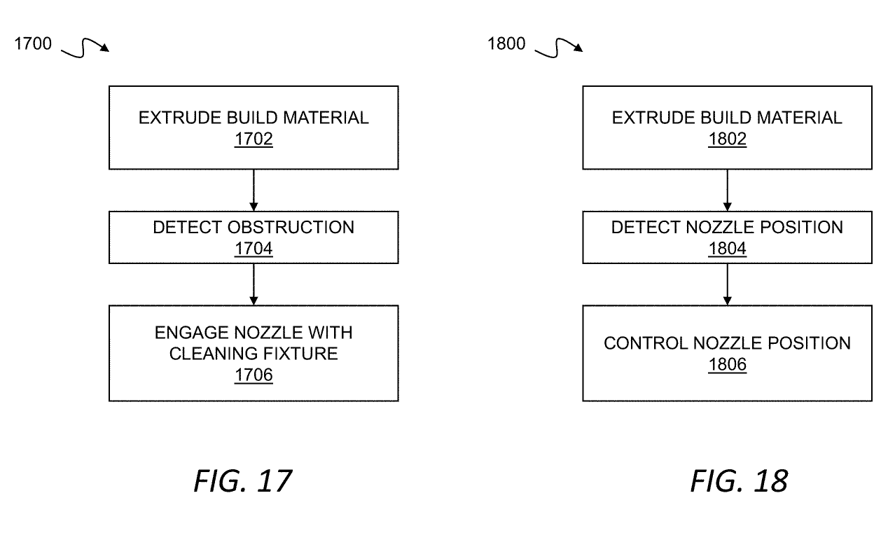

FIG. 17 shows a method for using a nozzle cleaning fixture in a three-dimensional printer.

As shown in step 1702, the method 1700 may include extruding a build material in a fabrication process. This may, for example, include extruding a metallic build material through a nozzle of the printer and moving the nozzle along a build path relative to a build plate of the printer to fabricate an object on the build plate in a fused filament fabrication process based on a computerized model of the object using any of the techniques described herein.

As shown in step 1704, the method may include detecting a potential obstruction. A number of techniques may be employed to detect obstructions to flow through an extrusion nozzle. This may, for example, include measuring an instantaneous force applied by a drive system to a filament or to the extruder that receives the filament, which may measure the amount of force required to drive the build material through the nozzle. A similar measurement may be obtained from rotary force applied by the drive system, or by an electrical or mechanical load on a drive system that drives the build material through the nozzle. In another aspect, the Seebeck effect or other techniques may be used to detect a state change of material within the nozzle indicative of clogging or hardening.

As shown in step 1706, when a potential obstruction is detected, the method 1700 may include moving the nozzle into engagement with a nozzle cleaning fixture to facilitate removal of obstructions using, e.g., any of the techniques described herein such as heating, physical displacement, or some combination of these. For a nozzle cleaning fixture that includes a pin, this may include maneuvering the nozzle into alignment with the pin and then inserting the pin through the opening of the nozzle using, e.g., the robotics system for the three-dimensional printer or a supplemental robotic system provided for spatial control of the nozzle cleaning fixture. This may also or instead include applying microwave energy from a microwave energy source to the metallic build material sufficient to liquefy the metallic build material, or applying a current from a current source through the metallic build material within the nozzle sufficient to liquefy the metallic build material. Any other similar mechanical or electromagnetic technique for physically dislodging obstructions may also or instead be employed by a nozzle cleaning fixture as contemplated herein.

FIG. 18 shows a method for detecting a nozzle position.

As shown in step 1802, the method 1800 may include extruding a build material in a fabrication process. This may, for example, include extruding a metallic build material through a nozzle of the printer and moving the nozzle along a build path relative to a build plate of the printer to fabricate an object on the build plate in a fused filament fabrication process based on a computerized model of the object using any of the techniques described herein.

As shown in step 1804, the method 1800 may include detecting a position of the nozzle based upon electrically detecting a contact of a surface of the nozzle with a contact probe at a predetermined location. The predetermined location may include a predetermined location within a build volume of the printer, a predetermined height relative to the build plate of the printer, or any other relative or absolute position within the coordinate system of the printer or the fabrication process.

As shown in step 1806, the method 1800 may include controlling a position of the nozzle based upon the contact between the nozzle and the contact probe. This may include controlling movement of the nozzle within a fabrication process when the contact is detected, or more generally controlling movement of the nozzle, such as by calibrating a position of one or more motors in a robotic system that moves the nozzle along the build path based on a detection of the contact with the surface of the nozzle.

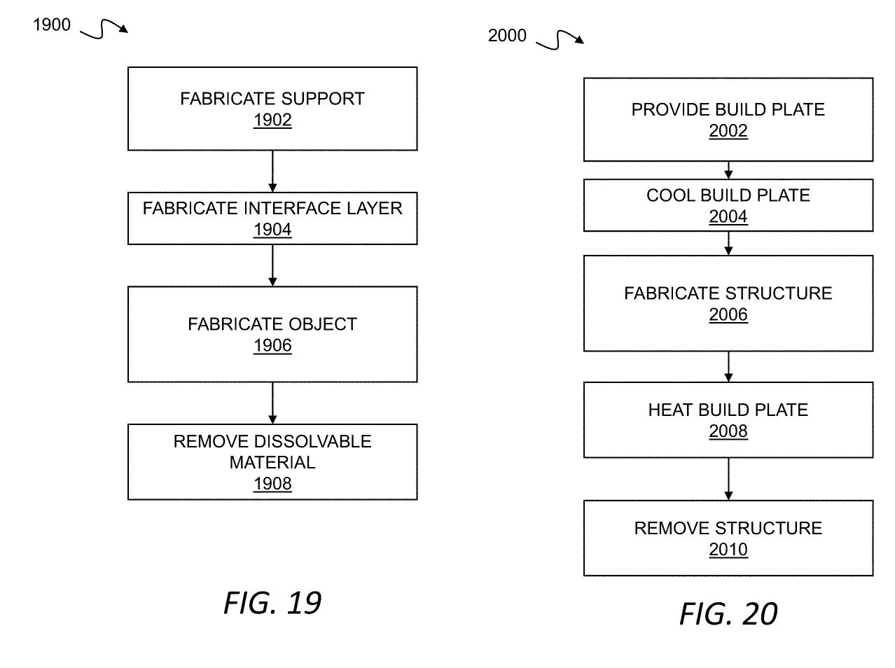

FIG. 19 shows a method for using dissolvable bulk metallic glass support materials. In general, this may include fabricating fully dissolvable supports, or fabricating a dissolvable interface layer between an object and a non-soluble support structure.

As shown in step 1902, the method 1900 may include fabricating a support structure. This may generally include a first nozzle along a first build path relative to a build plate of a printer while extruding a support material from the first nozzle to fabricate a support structure for an object. The support material may include a dissolvable bulk metallic glass, e.g., where the entire support structure is intended to be removed with a solvent, or the support material may be any other material suitable for supporting an object as contemplated herein.

As shown in step 1904, the method 1900 may include fabricating an interface layer. In particular, where the support structure itself is not soluble in a particular solvent, an interface layer may be separately fabricating between the support structure and an adjacent object surface, where the interface layer includes a dissolvable bulk metallic glass that can be removed with a solvent to release the object from the support structure. Many suitable bulk metallic glass alloys are known in the art. As described above, the dissolvable bulk metallic glass may include a magnesium alloy, a calcium alloy, or a lithium alloy.

As shown in step 1906, the method 1900 may include fabricating an object, such as by moving a second nozzle along a second build path relative to the build plate to fabricate a portion of an object above the support structure from a metallic build material, wherein the second build path is based upon a computerized model of the object. Where an interface layer is deposited as described above, the first nozzle and the second nozzle may be the same nozzle, and/or the support structure and the object may be fabricated from the same material. In either case, the resulting object may include an article of manufacture containing a support structure for additively manufacturing a portion of an object, the support structure formed of a dissolvable bulk metallic glass, and a surface of the object adjacent to the support structure, wherein the surface of the object is formed of a metallic build material.

As shown in step 1908, the method 1900 may include dissolving the dissolvable bulk metallic glass, either of the support structure or the interface layer. The aggregate structure may, for example, be immersed or rinsed in a suitable, corresponding solvent. Where appropriate, heat may be applied, or the solvent may be stirred, or energy may otherwise be applied to accelerate the dissolution process. The particular solvent used will be system dependent, but in various aspects this may include dissolving the bulk metallic glass in an aqueous solution such as water or an aqueous solution containing hydrogen chloride or other pH modifying acids or bases.

FIG. 20 shows a method for controllably securing an object to a build plate. In general, a build plate that receives the object during fabrication may include a coating of material with a low melt temperature (relative to the build material), such as a low melt temperature solder. In particular, the material may be an alloy that can be solidified while receiving the structure, and then heated into a liquid state to facilitate removal of the structure after fabrication at a temperature sufficiently low that the adjacent, fabricated object does not melt or deform.

As shown in step 2002, the method 2000 may include providing a build plate with a coating of a material having a melt temperature. This may include any of the build plates described herein. The melt temperature of the coating may be a temperature below a bottom of a working temperature range for a build material that is to be used with the build plate, e.g., a temperature where the build material remains solid. The coating may, for example, include a low melt temperature solder such as a solder alloy containing bismuth or indium.

As shown in step 2004, the method 2000 may include cooling the build plate. This may include cooling the build plate to maintain the coating at a temperature below the melt temperature when exposed to the metallic build material (which may tend to heat up the coating above the melt temperature when within the working temperature range), such as by constantly applying active cooling such as by internally fluid cooling the build plate, directing a cooling gas or fluid over the build plate, or otherwise continuously cooling the build plate independent of the actual temperature. This may also or instead include controlling an active cooling system to maintain the build plate at a target temperature, or within a target temperature range. It will also be understood that where the build chamber and the build plate remain sufficiently cool under normal printing conditions, the step of actively cooling the build plate may be omitted.

As shown in step 2006, the method 2000 may include fabricating a structure on the coating of the build plate with a metallic build material, wherein the metallic build material has a working temperature range with a flowable state exhibiting rheological properties suitable for fused filament fabrication. The structure may, for example, include any object described by a computerize model that has been submitted to the printer for fabrication (in suitable form or data structure). The structure may also or instead include a support structure for an object fabricated by the printer. As noted above, the melt temperature of the coating is preferably below a bottom of the working temperature range of the build material deposited on the build plate.

As shown in step 2008, after completing fabrication of the structure, the method 2000 may include heating the coating to a temperature above the melt temperature. In general, this may liquefy the coating on the build plate without melting or otherwise deforming the net shape of the structure, or alternatively, without substantially affecting the shape of the structure.

As shown in step 2010, the method 2000 may include removing the structure from the build plate while the coating is liquid. With the coating heated above the melt temperature, while the structure is concurrently in a solid state below a working temperature range, the structure may be removed from the build plate without substantial mechanical resistance from the coating.

Similar techniques may also or instead be employed to create a meltable interface to remove support structures from an object that required supports during fabrication. Thus, for example, a structure contemplated herein may include a support structure for supporting a portion of an additively manufactured object, a meltable interface layer formed of a low temperature alloy, and a surface of the object, wherein the meltable interface is disposed between the support structure and the surface of the object, and wherein the object is formed of a metallic build material having a melting temperature substantially greater than the meltable interface layer. The meltable interface layer may, for example, be formed of a low temperature solder such as any of those solders described herein.

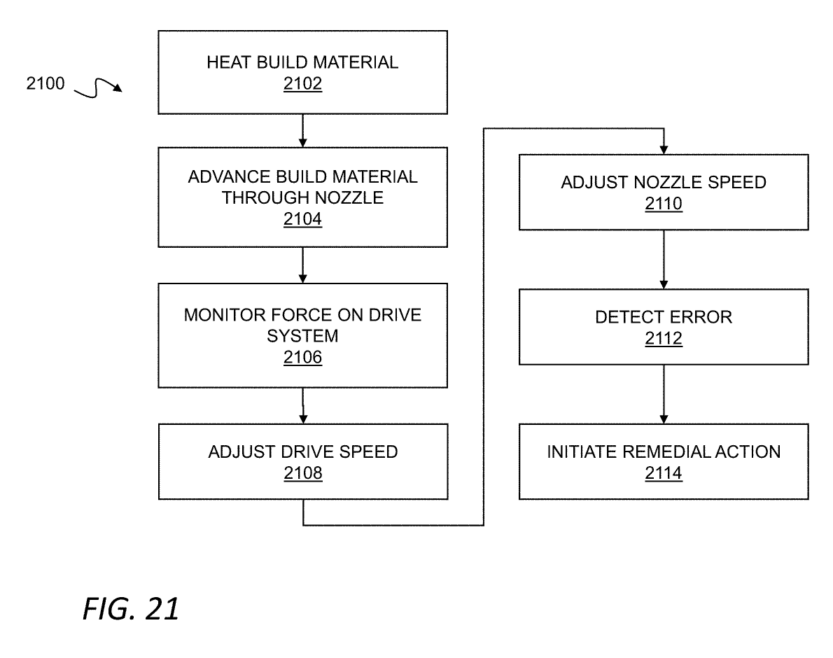

FIG. 21 shows a method for an extrusion control process using force feedback. In general, a control loop for extrusion of a build material such as metallic build material may measure a force required to extrude the build material, and then use this sensed parameter to estimate a temperature of the build material. The temperature, or a difference between the estimated temperature and a target temperature, can be used to speed or slow extrusion of the build material to control heat transfer from a heating system along the feedpath. This general control loop may be modified to account for other possible conditions such as nozzle clogging or the onset of crystallization. As a significant advantage, this may greatly improve thermal control by shortening the amount of time required to detect temperature on one hand, and by shortening the amount of time required to apply heat on the other. It should be appreciated that while the following technique is described as a technique for fabrication with metallic build materials, this may also or instead be usefully adapted to non-metallic fused filament fabrication materials such as acrylonitrile butadiene styrene, polylactic acid, and so forth.

As shown in step 2102, the method 2100 may include heating a build material such as a metallic build material with a heating system, such as any of the heating systems described herein. In general, this includes heating the metallic build material to a temperature within a working temperature range as generally contemplated herein.

As shown in step 2104, the method 2100 may include advancing the metallic build material through a nozzle of the printer at a speed with a drive system, such as any of the drive systems described herein.

As shown in step 2106, the method 2100 may include monitoring a force on the drive system resisting advancement of the build material through the nozzle. This may be monitored using any sensor or combination of sensors suitable for determining the load imposed on the drive system by the build material as it is advanced through an extruder. For example, this may include linear displacement sensors, force sensors, rotary sensors, or any other type of sensor for measuring related physical parameters such as the axial load on the extruder or nozzle by a feedstock, the rotary mechanical load on a motor of a drive system, or the electrical load on the drive system as it advances a build material through the extruder.

As shown in step 2108, the method 2100 may include adjusting the speed of the drive system according to the force on the drive system. This may include any proportional, integral, derivative or other system for applying the sensed force as a feedback signal to control drive speed. For example, this may generally include adjusting the speed by increasing the speed of the drive system to decrease a heat transfer when the force decreases. This may similarly include decreasing the speed of the drive system to increase the heat transfer when the force increases. That is, where increased force suggests increasing viscosity and lower temperature, the speed may be slowed somewhat so that the build material spends a greater amount of time near a heating system where more heat transfer can occur. And conversely, in response to a decreasing force (suggesting higher temperature and lower viscosity), the speed may be increased to decrease the amount of heating that occurs in a reservoir or other location where a fixed-location heating source applies heat. In general, a control system implementing this technique may maintain a predetermined target value for the force indicative of a predetermined temperature of the build material.

As shown in step 2110, the method 2100 may include adjusting a nozzle speed. In particular, this may include adjusting a nozzle movement speed in a fabrication process in proportion to the speed of the drive system in order to maintain a substantially constant material deposition rate for the fabrication process. As the drive speed changes, the extruded volume of build material will also change. In order to avoid over or under-extruding relative to the rest of an object as the extrusion rate changes, the speed of the nozzle in an x-y plane of the fabrication process may be adjusted in order to maintain a substantially constant volume distribution rate, and a correspondingly balanced or consistent spatial distribution of build material. More specifically, as the drive speed increases the nozzle speed should increase proportionally, and vice versa.

As shown in step 2112, the method 2100 may include detecting an error condition in the printer based on a relationship between the force on the drive system and the speed of the drive system. For example, the printer should respond to a decrease in drive speed (which provides more heating) with an increase in temperature, leading to a decrease in the axial, rotary or other load on the drive system. If, instead, the force increases, then an error such as a clog, build material crystallization or other malfunction may be inferred. Similarly, if a measured temperature (using a thermistor, Seebeck effect measurement, or the like) appears to be changing in a manner inconsistent with changes in the drive speed, then an error condition may similarly be inferred.

As shown in step 2114, the method may include initiating a remedial action in response to the error condition. This may, for example, include terminating a fabrication process, pausing a fabrication process, initiating a nozzle cleaning operation, notifying a user by audible tone, electronic communication or the like, or otherwise stopping the printer and/or explicitly requesting automated or manual intervention.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A printer for three-dimensional fabrication of metallic objects, the printer comprising:
a reservoir with an entrance to receive a metallic build material from a source, the metallic build material having a working temperature range with a flowable state exhibiting rheological properties suitable for fused filament fabrication;
a heating system operable to heat the metallic build material within the reservoir to a temperature within the working temperature range;
a nozzle including an opening that provides an exit path for the metallic build material from the reservoir;
a drive system operable to mechanically engage the metallic build material and to advance the metallic build material from the source into the reservoir with sufficient force to extrude the metallic build material, while at a temperature within the working temperature range, through the opening in the nozzle; and
a plasma source directed at the metallic build material exiting the nozzle.

2. The printer of claim 1 further comprising an ultrasound vibrator coupled to the nozzle and configured to apply ultrasound energy through the nozzle to the metallic build material exiting the nozzle.

3. The printer of claim 1 further comprising a shaping fixture to impose at least one ridge on a top surface of the metallic build material exiting the nozzle.

4. The printer of claim 1 further comprising a joule heating system configured to pass a current through the metallic build material across an interface between a first layer of the metallic build material exiting the nozzle and an underlying layer of the metallic build material.

5. The printer of claim 1 wherein the metallic build material includes a bulk metallic glass, and wherein the working temperature range includes a temperature above a glass transition temperature for the bulk metallic glass and below a melting temperature for the bulk metallic glass.

6. The printer of claim 1 wherein the metallic build material includes an off-eutectic composition, and wherein the working temperature range includes a range of temperatures between a lowest and highest melting temperature.

7. The printer of claim 1 wherein the metallic build material includes a composite material having a metallic base that melts at a first temperature and a high-temperature inert second phase in particle form that remains inert up to at least a second temperature greater than the first temperature, and wherein the working temperature range includes a range of temperatures above a melting point of the metallic base.

8. The printer of claim 1 wherein the metallic build material includes a peritectic composition and the working temperature range includes a range of temperatures where the peritectic composition exhibits an equilibrium volume fraction containing a substantial percentage by volume of liquid and a substantial percentage by volume of solid, and wherein the peritectic composition exhibits a medium viscosity of between about one hundred and one thousand Pascal seconds.

9. The printer of claim 1 wherein the printer comprises a fused filament fabrication additive manufacturing system.

10. The printer of claim 1 further comprising a build plate and a robotic system, the robotic system configured to move the nozzle in a three-dimensional path relative to the build plate in order to fabricate an object from the metallic build material on the build plate according to a computerized model of the object.

11. The printer of claim 10 further comprising a controller configured by computer executable code to control the heating system, the drive system, and the robotic system to fabricate the object on the build plate from the metallic build material.

12. The printer of claim 1 wherein the plasma source includes a variable chemistry plasma source.

13. The printer of claim 1 wherein the plasma source includes an ion plasma source.

14. The printer of claim 1 wherein the plasma source is directed at a location where the metallic build material exiting the nozzle joins an underlying layer of the metallic build material.

15. The printer of claim 1 wherein the plasma source is directed at a location on an underlying layer of the metallic build material before the metallic build material exiting the nozzle is deposited over the location.

16. The printer of claim 1 wherein the metallic build material includes aluminum.

17. A method for controlling a printer in a three-dimensional fabrication of a metallic object, the method comprising:
extruding a metallic build material through a nozzle of the printer;
moving the nozzle along a build path relative to a build plate of the printer to fabricate an object on the build plate in a fused filament fabrication process based on a computerized model of the object; and
joining the metallic build material as it exits the nozzle to an underlying layer of the metallic build material within a plasma stream.

18. The method of claim 17 further comprising applying ultrasound energy to the metallic build material exiting the nozzle while it is deposited over the underlying layer.

19. The method of claim 17 wherein the metallic build material includes at least one of a bulk metallic glass and an off-eutectic composition of eutectic systems.

20. The method of claim 17 wherein the metallic build material includes a composite material having a metallic base that melts at a first temperature and a high-temperature inert second phase in particle form that remains inert up to at least a second temperature greater than the first temperature, and wherein a working temperature range of the metallic build material includes a range of temperatures above a melting point of the metallic base.

21. The method of claim 17 wherein the metallic build material includes aluminum.
